(19) United States
(12) Patent Application Publication
(10) Pub. No.: US 2014/0218537 A1
(43) Pub. Date: Aug. 7, 2014

(54) System and method for disseminating information and implementing medical interventions to facilitate the safe emergence of users from crises

(71) Applicant: Michael Nepo, Woodside, NY (US)

(72) Inventor: Michael Nepo, Woodside, NY (US)

(21) Appl. No.: 13/928,110

(22) Filed: Jun. 26, 2013

Related U.S. Application Data
(60) Provisional application No. 61/761,304, filed on Feb. 6, 2013.

(51) Int. Cl. G08B 25/01; G08B 25/10

(52) U.S. Cl. CPC G08B 25/016; G08B 25/10
USPC 348/158; 340/539.11; 340/539.13; 340/539.12

(57) ABSTRACT

A method for disseminating information regarding a problem and administering medical interventions comprises providing a mobile device wirelessly connectable to a network, receiving and storing contact information corresponding to a designated list of information recipients, receiving, via the mobile device, a signal from a user indicating the problem, receiving, via the mobile device, information regarding the problem, transmitting an indication of the problem to a rescue clearinghouse via the network, prompting a participant of the rescue clearinghouse, different from the user, to make a decision about a course of action regarding the problem, and at least one of transmitting the information regarding the problem to the information recipients from the designated list and transmitting the information regarding the problem to a government rescue organization, based at least in part on the decision.

### REFERENCE TO RELATED APPLICATIONS

This application claims the benefit of U.S. Provisional Patent Application No. 61/761,304, filed Feb. 6, 2013, entitled “Ultimate Life Saver.”

### BACKGROUND OF THE INVENTION

Throughout history, millions of people faced life-threatening crises such as abductions, rape, sudden medical crises, car-jackings, robberies, and countless other dangerous situations. Historically, when a person found themselves in such a situation, it was impossible to instantly and discreetly alert loved ones and professional rescuers to the crisis, without alerting a potential attacker or abductor to the rescue attempt, and it was impossible to discreetly provide rescuers with data needed to understand the nature of the crisis, to enable rescuers to determine the user's current location, and to rescue the user. Often, police lack the vital information and evidence needed to identify, capture and prosecute attackers, or to understand the circumstances of any crisis from afar. Safety systems which require the user to engage in a verbal conversation with the rescuers are dangerous and not usable in a situation such as an abduction, because the attacker will hear the discussion with the dispatcher and terminate the communication. Safety systems which lack a portable, physical panic-trigger device and which force the user to interface with the system exclusively via a smartphone application, are impossible to discreetly and rapidly use during a sudden attack, because it takes too long for users to A) awaken the phone screen B) unlock the screen C) locate the application D) launch the application and finally, E) trigger a panic within the application. No attacker will allow a user to retrieve their phone from their pocket and do the above actions, during an attack. Throughout history, if a person was alone and lost consciousness, there was very little likelihood that they would have been rescued. Historically, if a user is in need of a dose of medicine, it has been difficult for many users to administer the correct dosage at the correct times, particularly if this medical emergency renders the user unconscious. As can be seen, there is a need for solutions to these and other problems, and Ultimate Life Protector™ provides solutions to each of them as detailed herein.

As can be seen, there is a need for solutions to these and other problems.

### SUMMARY OF THE INVENTION

Ultimate Life Protector™ is a personal portable safety system designed to facilitate the user's safe emergence from all manner of dangerous crises, which empowers users with the ability to discreetly and instantly notify designated loved-ones and local professional rescuers instantly if a crisis begins. Unbeknownst to a potential attacker, real-time data from the user such as their current and past location(s), audio, vantage-point video and photos are provided to mobile and desktop websites, which serve as a central clearinghouse to provide rescuers with everything they need to quickly understand the nature of the crisis, to instantly communicate with other rescuers, and to locate and rescue the user from potential harm. With the Safe Journey Timer, unconscious users can be located and rescued without actively triggering a panic.

The essential components of the system are as follows: A) Portable, thumb-sized panic trigger device. B) Smartphone software which triggers panics to notify rescuers of a crisis via SMS and email panic messages, transmits the user's location data, audio and vantage point video. C) Website for mobile and desktop internet-enabled devices, which serves as the central clearinghouse of information needed to rescue the user. D) 24/7/365 Rescue Center receives the panic messages, and immediately contacts the nearest public rescue service to the user via the compiled database of all local rescue services worldwide. E) Safe Journey Timer allows users to set the timer for the expected duration of a journey. When the timer runs out, the user is reminded via phone vibrations to cancel the countdown. If the user is unconscious or otherwise unable to access the phone, a panic is automatically triggered, without the user's conscious involvement. F) Several optional accessories are available to monitor various aspects of the user's current health condition, and if these conditions reach a critical level, a signal is sent to the user's smartphone, triggering a panic, and distributing information about the user's health status on the rescue website.

In one aspect of the present invention, a method for disseminating information regarding a problem comprises: providing a mobile device wirelessly connectable to a network; receiving and storing contact information corresponding to a designated list of information recipients; receiving, via the mobile device, a signal from a user indicating the problem; receiving, via the mobile device, information regarding the problem; transmitting an indication of the problem to a rescue clearinghouse via the network; prompting a participant of the rescue clearinghouse, different from the user, to make a decision about a course of action regarding the problem; and at least one of transmitting the information regarding the problem to the information recipients from the designated list and transmitting the information regarding the problem to a government rescue organization, based at least in part on the decision.

In one aspect of the present invention, a method for disseminating information regarding a problem comprises: providing a mobile device wirelessly connectable to a network; receiving and storing contact information corresponding to a designated list of information recipients; receiving, via the mobile device, a signal from a user indicating a safe time period; measuring an elapsing of the safe time period; and either a) or b) but not both: a) within the safe time period, receiving a completion indication from the user; b) transmitting an indication of a problem to a rescue clearinghouse via the network; prompting an operator of the rescue clearinghouse, different from the user, to make a decision about a course of action regarding the problem; and at least one of transmitting the information regarding the problem to the information recipients from the designated list and transmitting the information regarding the problem to a government rescue organization, based at least in part on the decision.

These and other features, aspects and advantages of the present invention will become better understood with reference to the following drawings, description and claims.

### BRIEF DESCRIPTION OF THE DRAWINGS

Herein, when selectable button-options are described, they are shown CAPITALIZED.

FIG. 1 is a representation of the TEST PANIC home screen within the smartphone application. The TEST PANIC modes are meant to teach users and emergency contacts how the system works, without contacting the authorities. All messages sent clearly state that this is not an emergency. No test messages are sent to the Armed Rescue Center. On this screen, users have the option to trigger a TEST SILENT, TEST LOUD, or TEST MEDICAL PANIC, TEST the SAFE JOURNEY TIMER and to view the MORE MENU items.

FIG. 2 is a representation of the application screen shown after a TEST SILENT PANIC has been triggered. On this screen, users have the option to sound an audible alarm with the SOUND ALARM button, send emergency contacts a FALSE ALARM MESSAGE by pressing the FALSE ALARM MESSAGE button, CANCEL PANIC, and CALL 911.

FIG. 3 is a representation of the mobile rescue website, intended for use on portable, internet-enabled, smartphone-sized devices, after a user has triggered a TEST PANIC. The user's current location is shown as a “HELP ME” icon on the map. Rescuers can select the “Press For Menu Items” bar at the top of the screen to view various data options detailed in FIG. 28.

FIG. 4 is a representation of the desktop rescue website after the user has triggered a TEST panic. During a TEST panic, all data which is normally transmitted during a “REAL” panic are also transmitted to the website during a TEST panic. Video, photos, audio, panic status, current and previous locations are sent to the website during a TEST panic.

FIG. 5 is a representation of the primary HOME screen for the Ultimate Life Protector application. On this screen, users are able to ARM and DISARM the rescue center, trigger a Silent, Loud or Medical Panic, use the Safe Journey Timer, access additional features via the MORE MENU, and rapidly call 911 with a dedicated button.

FIG. 6 is a representation of the application screen which appears after a SILENT PANIC has been triggered. On this screen, users have the option to sound an audible alarm with the SOUND ALARM button, notify rescuers and contacts that this panic was accidentally triggered with the FALSE ALARM button, CANCEL PANIC, and CALL 911.

FIG. 7 is a representation of the application screen which appears after a LOUD PANIC has been triggered. As this screen appears, the camera flash shows brightly as a photo is taken, a loud police siren plays through the phone speakers, along with a loud voice which clearly declares, “Your pictures have been sent to the authorities.” On this screen, users can silence the alarm with the MUTE button, notify rescuers of a FALSE ALARM, CANCEL PANIC, and CALL 911.

FIG. 8 is a representation of the application screen which appears after a MEDICAL PANIC has been triggered. On this screen, users have the option to sound an audible alarm with the SOUND ALARM button, notify rescuers and contacts that this panic was accidentally triggered with the FALSE ALARM button, CANCEL PANIC, and CALL 911.

FIG. 9 is a representation of the primary panic trigger device. When the user double-presses the PANIC button, the signal is sent via Bluetooth to the user's smartphone. This causes the application to launch, and then for the PANIC to be triggered.

FIG. 10 is a representation of the user triggering a SILENT PANIC via the primary HOME screen for the Ultimate Life Protector application.

FIG. 11 is a representation of the user triggering a SILENT PANIC by double-pressing the button on the side of the user's ear-mounted video camera. As with the primary panic trigger device, the panic signal is transmitted via Bluetooth.

FIG. 12 is a representation of the application screen which appears after a SILENT PANIC has been triggered via the Bluetooth-enabled devices, via the panic buttons present on the application screen, and/or via the elapsed Safe Journey Timer.

FIG. 13 is a representation of the user's designated emergency contacts as they receive the SMS and email panic messages.

FIG. 14 is a representation of the dedicated Rescue Center as they receive the panic messages. The Rescue Center immediately contacts the public rescue service nearest to the user's current location.

FIG. 15 is a representation of a user selecting the SAFE JOURNEY TIMER from the primary HOME screen of the Ultimate Life Protector application.

FIG. 16 is a representation of the application screen which appears after the user selects the ‘SAFE JOURNEY TIMER’ option from the application screen. The user enters the estimated length of their upcoming journey, in minutes, 10 minutes in the case of this representation, and then the user selects the START button to start the timer countdown.

FIG. 17 is a representation of the application screen which appears after the user starts the SAFE JOURNEY TIMER countdown. In the case of this representation, 9 minutes and 48 seconds remain in the countdown. During the SAFE JOURNEY TIMER countdown, users have the option to cancel the countdown by selecting ARRIVED SAFELY. If the user suddenly faces a crisis before the countdown is complete, on this countdown screen, users can select the SILENT PANIC button, to trigger an immediate panic. Users can also trigger a panic by double-pressing the panic button on the primary panic trigger device, before the countdown has reached zero. If the user's journey is not complete, and the user wishes to extend the length of the countdown, users can select the RESET TIMER button, to add additional minutes to the countdown.

FIG. 18 is a representation of the SAFE JOURNEY TIMER countdown screen when the timer reaches the final 30 seconds of the countdown. The phone vibrates for each of the final 30 seconds of the countdown, to remind users that only 30 seconds remain before a panic will be triggered.

FIG. 19 is a representation of the SILENT PANIC screen which appears after the SAFE JOURNEY TIMER countdown reaches zero.

FIG. 20 is a representation of the user's designated emergency contacts as they receive the SMS and email panic messages.

FIG. 21 is a representation of the dedicated Rescue Center as they receive the panic messages. The Rescue Center immediately contacts the public rescue service nearest to the user's current location.

FIG. 22 is a representation of the front of the primary panic trigger device. When the user double-presses the PANIC button, a signal is sent via Bluetooth to the user's smartphone. This causes the application to launch, and then for the PANIC to be triggered. When the user's smartphone successfully receives the panic signal from the trigger device, and successfully triggers a panic, the trigger device vibrates, to confirm to the user that the panic has been triggered. An LED is present on the front of the trigger device, to convey various data to the user.

FIG. 23 is a representation of the side of the primary panic trigger device. A metal clip is attached to the rear of the trigger device, with a tightly wound metal spring which pressures the clip to close. At the bottom of the metal clip, a button snap is present, enabling the user to firmly attach the device to clothing, purse straps, and every material where it is possible to attach a clip to the material, and to snap a button so that the device is firmly secured. A hole is present on the clip, enabling users to attach the device to a keychain.

FIG. 24 is a representation of the bottom of the trigger device, where a USB port is present. Users can recharge the battery via this USB port, and additionally can interface with the user's computer, to upgrade firmware on the device.

FIG. 25 is a representation of a standard USB cord which can provide power to and interface with the panic trigger device.

FIG. 26 is a representation of the rescue website which appears on large, desktop/laptop/tablet-sized computer screens. Each rescue website is unique to the specific user in question; to be viewed by designated panic message recipients, and by new people who the designated panic message recipients communicate with. When a rescuer arrives at the website via this large computer screen, the following features are available: A) The user's current location is shown as a “HELP ME icon which appears on the map. B) When rescuers click on the HELP ME icon, they are provided with turn-by-turn directions to the user. C) Contact information for the nearest public rescue precinct to the user's current location is shown. All panic message recipients are instructed to contact this local precinct. D) Streaming video and/or photos appear on the screen. E) A name field is present for website attendees to enter their name, and then begin text and/or voice and/or video chatting with fellow panic message recipients, to share vital information during the panic. F) The status of the user's panic is shown, including the time and date when the panic began, which type of panic was triggered, and whether or not the panic is still currently active. G) The user's home address and phone number is shown. H) A photo of the user is shown, so rescuers can identify the user when they arrive at the user's location. I) Rescuers can center the map upon the user's current location by selecting the USER'S CURRENT LOCATION button. J) Rescuers can see the user's location history during and before the user's panic was triggered by selecting the USER LOCATION HISTORY button. K) Rescuers can listen to audio recorded from the user's location during a panic by selecting the AUDIO FROM THE SCENE button. L) Rescuers can view contact information for the user's designated emergency contacts by selecting the EMERGENCY CONTACT INFO button. M) Rescuers can view relevant medical information to the user by selecting the MEDICAL INFO button. N) Rescuers can view a visual representation of the user's past movements via a colored line which appears on the map.

FIG. 27 is a representation of the rescue website which automatically appears on internet-enabled mobile smartphones, and other small-screen devices. When rescuers first arrive at the mobile website, the user's current location is displayed as a “HELP ME” icon which appears on a map. Access to several menu items is achieved when the rescuer selects the PRESS FOR MENU ITEMS button on the screen.

FIG. 28 is a representation of the mobile rescue website screen which appears after the website viewer selected the “PRESS FOR MENU ITEMS” button. The following items are available to the rescuer: A) The name and phone number of the user. B) A photo of the user, so they can be identified by public rescuers. C) The home address of the user. D) Medical information which is relevant to the user. E) Contact information for all of the user's designated emergency contacts. F) Ability for rescuers to text and/or voice and/or video chat, to communicate with fellow rescuers. G) Contact information for the nearest public rescue precinct to the user's current location is shown on the screen. H) If the rescuer wishes to close the MENU ITEMS, they can select the “FULL SCREEN MAP” button. When this is selected, the menu items disappear and the viewer sees the HELP ME icon on the map, and the “PRESS FOR MENU ITEMS button reappears. I) Video and/or photos from the user's location during a panic is available to the rescuers. J) Audio from the user's location during a panic is available to the rescuers. K) Rescuers can view a visual representation of the user's past movements via a colored line which appears on the map. L) Rescuers can view the user's location history in the form of approximate street addresses and latitude/longitude data of the user's past locations, before and during an active panic. M) Rescuers can center the map upon the user's current location by selecting the USER CURRENT LOCATION button.

FIG. 29 is a representation of the rescue website screen which appears if the rescuer selects the USER LOCATION HISTORY button. The latitude/longitude numbers which show the user's past movements are shown, in addition to approximate street addresses to the user's past movements. The date and time when the user was in different locations is shown, updated at regular intervals, allowing rescuers to understand when the user was in each location.

FIG. 30 is a representation of the rescue website screen which appears if the rescuer selects the AUDIO button. The time and date when the audio began to be recorded is shown. The current status of the panic is shown. In this case, the panic is ACTIVE. An audio player is shown, and as the audio is played, a clock shows what time each portion of audio was recorded. Rescuers can skip to different portions of the recording by dragging an audio icon either forwards or backwards. As the audio icon moves, the clock moves, so rescuers can forward or rewind to the time of their choice.

FIG. 31 is a representation of the screen which appears if the rescuer selects the HELP ME icon. When this HELP ME icon is selected, a field appears which reads, “Enter your current address to get directions to the user's location.” On this screen, the rescuer enters their own current street address.

FIG. 32 is a representation of the screen which appears if the rescuer enters their current street address into the field described in FIG. 31. After submitting their current street address, in this representation, rescuers are shown turn-by-turn directions from the rescuer to the user.

FIG. 33 is a representation of the website screen which appears if the rescuer selects the VIDEO button. Rescuers can either view previous photos and video, or in this case, when new video is streaming live during an active panic, rescuers can select the VIDEO CURRENTLY STREAMING LIVE button, to enlarge the current video. Regardless of whether or not the rescuer selects the VIDEO CURRENTLY STREAMING LIVE button, if new live video is being recorded, the live video is automatically shown in the smaller thumbnail sized square on the screen.

FIG. 34 is a representation of the website screen which appears if the rescuer selects the button, “VIDEO CURRENTLY STREAMING LIVE”, to enlarge the live video, and to display a control panel. On this control panel, rescuers can control the audio volume, can pause and play the video, and as with the audio player detailed in FIG. 30, the video screen also allows rescuers to skip to different portions of the recording by dragging a video icon either forwards or backwards. When the rescuer moves to a different portion of the recording, the clock-time when that portion took place is shown.

FIG. 35 is a representation of a user who is wearing the ear-mounted video camera during a panic. All video is recorded from the user's own vantage point, so whichever direction the user looks, video from that direction is recorded. In this case, the user is looking at and recording an attacker.

FIG. 36 is a representation of an attacker whose movements and actions are being recorded by the user's ear-mounted video camera during a panic.

FIG. 37 is a representation of the transdermal medicine distribution patch. The patch(es) attach to the user's skin via adhesive, and in this representation, the medicine remains sealed in the medicine reservoir. In this state, the medicine does not make contact with the user's skin.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Ultimate Life Protector™ is a safety/rescue system designed to facilitate the user's survival and rescue from any number of dangerous crises.
The primary components to the system are as follows:
1. Smartphone software application.
2. Thumb sized bluetooth panic button which sends signals to the smartphone application.
3. Server/Cloud database.
4. Rescue Website
5. Dedicated 24/7 Rescue Center.
6. Additional optional accessories.
   In all cases herein, when the formula is explained for entering text within the websites, emails and application, when words are shown in between the following symbols “[ ]”, the content is an unknown variable, and is meant to be automatically inserted when the variable becomes known. For instance, “Hi [EMERGENCY CONTACT'S NAME],” In this example, the applicable recipient's name is automatically inserted within the [ ]. For instance, “Hi Bob Johnson”,

### 1. Smartphone Software Application:

Smartphone software application is created in several coding languages required to be compatible with all major smartphone operating systems including but not limited to: Android, iOS, Blackberry, Windows, Symbian, Bada, Maemo, Moblin, MeeGo, Palm and webOS. When new smartphone operating systems become widely used, the software code is translated into the new language, enabling the same Ultimate Life Protector™ algorithm to function on the new smartphone. Regardless of the operating system, the same core Ultimate Life Protector™ algorithm functions on all suitable smartphones and portable, internet-enabled devices.
The application algorithm is detailed below:

### 1-A) Installation and Setup:

After installation, during the first launch of ULP, the user is prompted to do the following tasks below: If the user quits the application before entering the required information, when the user re-launches the application, they are automatically returned to the signup process described below, and the same continues to happen after application launch until the user enters the information; namely (1) a unique username, (2) their own contact info (3) contact information for at least one emergency contact who can be invited to participate to help facilitate the user's rescue during an emergency.
The order of the signup process is detailed below:
1) The user is prompted to select a unique user name. If the entered user name is already in use, the user is prompted to create a unique user name. The user name is what makes the user's web link unique.
2) The user is prompted to enter their own personal contact info, namely, their cell phone number, email address, and physical home address.
3) The user is prompted to take a picture of themselves, so rescuers can know what the user looks like during the rescue.
4) The user is prompted to enter up to 10 emergency contacts, which should include trustworthy loved ones and campus security if applicable, with cell phone numbers capable of receiving SMS, in addition to email addresses.
5) At the end of this initial sign up process, after all the user's information has been entered, the user is sent to the TEST PANIC screen. A pop up message informs the user that they must first trigger a TEST panic before gaining the ability to trigger a REAL panic. If the user QUITS the application at this time, before a test panic has been triggered, when the user re-launches the ULP application, they are returned to the TEST panic screen. Until the user triggers a TEST panic, they are brought to the TEST PANIC screen each time they launch the application. This requirement ensures that all users have at least one experience using Ultimate Life Protector™, to gain a basic understanding of how it functions, before experiencing a true emergency.
6) When the user triggers the very first TEST panic, all emergency contacts are automatically sent an email which formally invites them to participate as this user's emergency contact in case of a crisis. The invitation email contains the following text:

### Hi [RECIPIENT'S NAME],

It's [NAME OF USER] here. I'm writing because I just signed up for a safety service called Ultimate Life Protector™. I need to enter contact info for 10 emergency contacts and I'm hoping you won't mind being one of them.
What I need is very simple. If I launch a panic to indicate that I'm in great danger, my contacts (like you) will receive an SMS text which has a web link. All I need you to do is to call 911 and tell them to go to that link. Simple! The link is http://www.LocateLovedOne.com/MyName. You can also click the link yourself right on your phone, to see where I am, hear live audio and much more.
Professional rescuers like the police can use this web link to track my location, so they can rescue me. If you have any questions or you don't want to be one of my emergency contacts, please let me know.
Thanks either way!

### [User's Full Name]

[555 555 5555]
[user's email address]
Learn more about this safety/rescue service and sign up yourself at http://www.UltimateLifeProtector.com.

### 1-B) Test Panics: Experimenting for Users and Contacts to Learn how ULP Works:

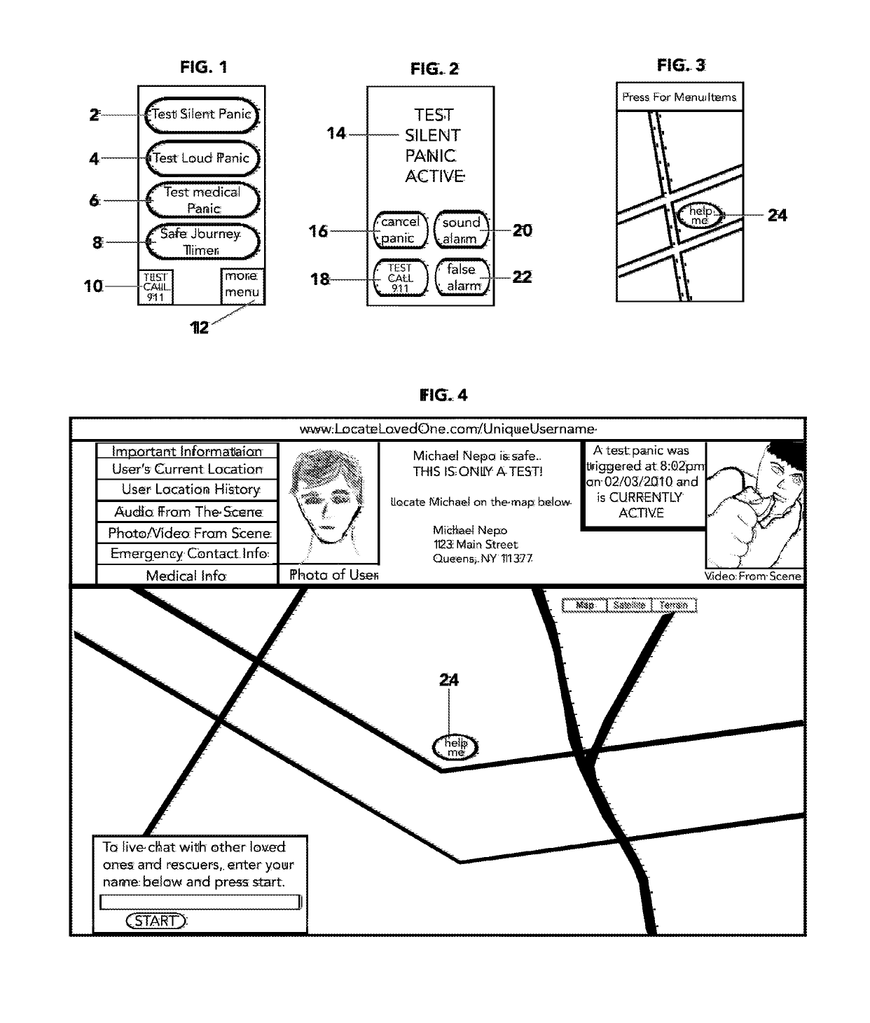

After the first TEST PANIC, described above in a), during which time the emergency contacts are first invited (via email and SMS) to participate with the user, the user is able to continue to trigger Test Panics. TEST PANIC is located in the MORE MENU of the application. Users are encouraged to frequently trigger TEST PANICS before ever using ULP in a real situation. This is encouraged to help user and their emergency contacts to learn all about the various functions and features within Ultimate Life Protector™ WITHOUT contacting the authorities.
The TEST PANIC screen shown in FIG. 1 contains six main button options, which are, (2) “Test Silent Panic”, (4) Test Loud Panic, (6) Test Medical Panic, (8) Test Safe Journey Timer, (10) Test CALL 911, and (12) More Menu. If the user triggers a Test Silent Panic, the active panic screen shown in FIG. 2 appears, which (14) displays the current panic status, and contains four main button options, which are, (16) Cancel Panic, (18) Test Call 911, (20) Sound Alarm, and (22) False Alarm.
All functions act as it normally would during a REAL panic, except (A) the Rescue Center is never contacted during a Test Panic, and (B) during a TEST PANIC, the panic SMS and email messages clearly state that this is not a real emergency. It is a Test Panic, being done to give the user and the emergency contacts experience using Ultimate Life Protector™, so they are prepared to assist with a rescue in case of a real emergency. Also, TEST PANIC allows the user to confirm that all of the phone numbers and email addresses for emergency contacts are current and correct. Recipients receive Test Panic messages, at which time they can click directly on the user's web link, with which they can repeatedly visit the website, to fully to understand all the various features available to aid with a rescue. Emergency contacts can click the web link on their web-enabled smartphones, as well as from within email on their desktop, laptop and tablet devices.
To be clear, the user's location is only shown on the website during active panics. If the SMS recipient clicks on the web link during the ACTIVE Test Panic, the recipient is immediately taken to the user's personal mobile website, and once the webpage opens, the recipient can view the user's current location as shown in the form of a blue icon which sits on the map, which reads, “HELP ME. This (24) HELP ME icon can be seen in FIG. 3 representing a test panic on mobile smartphones, and also in FIG. 4. representing a Test Panic for desktop, laptop and tablet devices. As soon as the user cancels the active panic, the HELP ME icon disappears from the website maps, hence the website viewer can no longer view the user's current location after the user cancels a panic. Emergency contacts are still able to view the user's past locations, recorded video, audio, among several other data gathered during the active panic.
The text of the Test Panic email is as follows:
Subject—“TEST PANIC from [USER'S NAME]

### Hi [EMERGENCY CONTACT'S NAME],

This email is a test panic message from my rescue service called Ultimate Life Protector. If this were a real emergency, I would need for you to immediately call 911 and tell them to locate and rescue me at the following website. You can click on it now to see where I'm located, to hear audio from my position, and to generally learn what the website can offer in case of a real emergency.
http://www.LocateLovedOne.com/[UNIQUE USER NAME]
In a real emergency, I need for you to call 911 if you ever get this panic message from me. Just tell 911 the web address above, and they'll be able to rescue me. In a real emergency, when you call me to confirm, you can ask me for my password. It is [INSERT PASSWORD] If I don't tell you the correct password, it means that I am under duress.
Thank you for agreeing to help me if I'm in danger!

### [USER'S FULL NAME]

### [USER'S CELL PHONE NUMBER]

### [USER'S EMAIL ADDRESS]

### 1-C) Arming and Disarming the Rescue Center:

When the user first installs and signs up for Ultimate Life Protector™, the default mode for the Rescue Center is to be DISARMED.
The user must actively arm it by pressing “ARM” at the bottom of the application. A pop up screen appears which reads, “Warning! When Rescue Center is armed, the authorities will be notified when a panic is triggered, so arm rescue center with caution. Once armed, the Rescue Center will remain armed until you disarm it.” When ARMED, it reads “Rescue Center is currently ARMED” at the top of the application screen. If the Rescue Center is disarmed, it reads, “Rescue Center is currently DISARMED” at the top of the application screen.
The user is urged to use the ARMED system with great caution, because if a panic is triggered, the ULP 24/7/365 Rescue Center will receive all panic messages, and summon professional rescuers to immediately begin to attempt to rescue the user. This must be avoided if the user doesn't face true danger. A detailed description of the protocols followed by the ULP 24/7/365 Rescue Center is provided near the end of this document in #5, 24/7 Rescue Center.
It is highly recommended that the user experiments with and learns a great deal about the system before activating ARMED mode. While DISARMED, the user can experiment with all functions, allowing loved ones and the user to learn all about how these functions can be useful in case of a real emergency.
If the user attempts to ARM the rescue center, they first read the warning pop up message described above. They are offered two buttons to choose from: “Arm Rescue Center” and “Cancel”. After selecting “ARM Rescue Center”, they are prompted to enter their correct password. After the correct password is entered, the ULP rescue center is ARMED. It remains ARMED every time the user uses Ultimate Life Protector™, until the user actively DISARMS it. In other words, once ULP is armed, it remains armed until the user DISARMS it. Even when the user quits ULP and turns off the phone, when the phone is powered on, and a panic is triggered, the previous ARMED or DISARMED setting always remains in effect until and unless the user changes the setting.

### Intended Uses for Disarm Mode Below:

DISARM mode is intended for many uses beyond as a tutorial device. ** In all cases where the user has decided to use the system for any non-emergency such as described in numbers 3 and 4 below, the user selects the “Non-Emergency” button which is available in the menu items. When this mode is selected by the user and the user then triggers any panic mode, all emergency contacts receive SMS and email messages which clearly state that this “panic” is not life threatening, but the user does request their assistance. If users choose to use a panic in a non-emergency mode, before triggering a “panic”, users are strongly encouraged to notify all emergency contacts that the user is not facing a real crisis, via a pop up screen which appears after the user presses the “Non-Emergency button”. The pop up screen reads, “If you intend to trigger a panic during a non-emergency, you are strongly encouraged to send a warning message to all contacts.” The two button options which appear underneath the pop up screen read, “Send Warning” and “Cancel”. If the user selects “Cancel”, a new pop up screen appears which reads, “Non-Emergency Mode cancelled. All panics will be treated as real emergencies.” If the user selects, “Send Warning”, SMS and email messages are sent to all emergency contacts, clearly stating that the user is currently safe, but intends to send a non-emergency panic. The contact's help might be requested by the user, but not for a life-threatening emergency. Possibly an awkward social situation which the contact can “rescue” the user from.

### 1) Monitoring Young Children and Dementia Sufferers:

DISARM mode is intended to give adults the ability to constantly monitor their young children in a variety of intuitive and useful ways, in non-life threatening situations, e.g., walking with a child at an outdoor festival. One option for the parents is, to trigger a panic on the child's ULP device before entering an outdoor festival, shopping mall, or any number of other large places, where the guardian is concerned that they might lose sight of the child. With the panic active, the parents and children can walk around the large space confidently, because if they suddenly lose sight of their child, they simply awaken their smartphones, and instantly see exactly where the child is located, in addition to various other vital data.
Constant monitoring of a user must always be with the consent of the user, and is only intended for young children in examples such as above, or possibly to monitor a user suffering from dementia or other mental issues which call for urgent, constant monitoring. In nearly all cases with Ultimate Life Protector™, it is the user alone who controls whether or not their location and audio/video are being monitored.
User Privacy: It is not possible to trigger a panic remotely. The panic must be triggered on the smartphone owner's phone, via the provided bluetooth button or other methods described herein. It is not possible for a different person to remotely trigger a panic on the user's phone, to monitor the user's location, audio and more, without the user's knowledge. Any smartphone user can simply power off and restart their smartphone to disable the software. Ultimate Life Protector™ is designed to give vast powers needed to rescue the user, in the hands of the user.
In short, no user is monitored until a panic is triggered on the user's smartphone. In nearly all cases (aside from young children/dementia above) it will be the user who decides that they are suddenly facing a dangerous crisis, and in such cases, the user simply double-presses their bluetooth panic button, among other panic trigger methods described herein.

### 2) Mildly Risky Situations:

Another specific intended use of DISARM mode is for teen age children during non-life-threatening situations, such as an unchaperoned teen age party, for instance. In these cases, the user can double-press their bluetooth button if the user wants to inform other friends who are present at the party that they are uncomfortable with a situation, perhaps involving an intoxicated, aggressive male classmate. The user retains the power to determine whether or not they trigger a panic. Since the panic message recipients are at the very same party or event, the friends can instantly rescue the user who is in another room. If the user chooses, she can include her parents on the list of panic recipients. The parents can listen to the audio of the situation and determine their next course of action.
3) Rescue from Socially Awkward Situations:
Another intended use for DISARM mode, is for a user who has no crisis whatsoever, but merely wishes to notify their nearby friend or associate that they are uncomfortable in a situation. For instance, one user might bring two friends to a social gathering. The user might wish to be “rescued” from the awkward conversation they are engaged in, or perhaps a celebrity discreetly triggers a DISARMED panic to notify her publicist that she wants to stop giving an interview. In other words, she wants the publicist to “rescue” her from the interview. In short, after the user has DISARMED the Rescue Center, and notified her Emergency Contacts that she is planning to use ULP in a specific, non-dangerous situation, the user can double press a discreet button to be “rescued” from any socially delicate situation.
4) Rescue from First Dates/Blind Dates:
Another example of a specifically intended use for DISARM mode is for romantic first dates with a new acquaintance. Users might wish to have their close friends available, prepared to receive the ULP SMS if the user becomes uncomfortable with their situation, even if they don't necessarily initially perceive the situation to be physically dangerous. The friend receives the message and immediately hears audio, possibly live video, and the user's location. The message recipient can both call the user, and go to the user's location.
In such a situation, where the user might originally have believed that there was no physical danger, but the panic message recipient listens to the ULP audio stream, and/or views the user's video stream, and believes that the user might be in actual physical danger, the message recipient simply calls the nearest professional rescue precinct shown on the rescue website, and tells the rescuers the user's unique web link. www.LocateLovedOne.com/[UNIQUE USER NAME].
These nearby rescuers can use the link to locate and rescue the user, while gathering all the timely data described herein.
In other words, even if the user DISARMED the Rescue Center, if emergency contacts/panic message recipients listen to the user's audio, and view the user's video, and these cause the Emergency Contacts to believe that the user faces a truly dangerous crisis, they can instantly contact professional rescuers, and by providing them with the user's web link, the rescuers treat the emergency as if the user intended for the Rescue Center to be ARMED. This is the case even when the Rescue Center is DISARMED.
A detailed description of the protocols followed by the ULP 24/7/365 Rescue Center is provided near the end of this document in #5, 24/7 Rescue Center.

### 1-D) the ULP Application Home Screen:

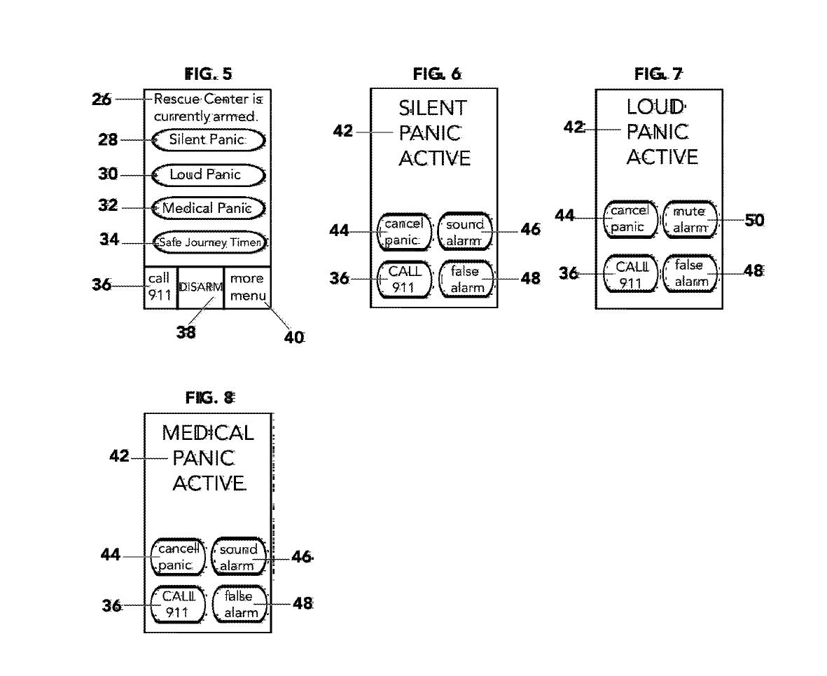

FIG. 5 represents the HOME screen of the Ultimate Life Protector™ application. (26) At the top of the screen, it is shown whether or not the Rescue Center is ARMED or DISARMED. In this example (26), it reads, “Rescue Center is currently ARMED”. Directly underneath the arming status, (28) the Silent Panic button is displayed. When the user selects this button, Silent Panic is triggered. Underneath this button, (30) the Loud Panic button is displayed. Beneath that button, (32) the Medical Panic button is displayed. Under that button is (34) the Safe Journey Timer button. Safe Journey Timer is detailed below at (1-I)
At the bottom left of the screen is (36) the Call 911 button. When the user presses this button, they are instantly transported to the outgoing phone call screen of the user's phone with 911 pre-dialed. 911 is reached with two taps of the screen. The first tap is to select the “CALL 911” button, and the second tap is to select “CALL” on the standard phone outgoing call screen. The user can (38) ARM or DISARM the Rescue Center with the button at the bottom/center of the screen, and finally, the user can select (40) the More Menu at the bottom right of the ULP HOME screen, to view various available options detailed below in (1-J).
1-E) there are 3 Primary Panic Modes in ULP. Silent Panic, Loud Panic, and Medical Panic:
FIG. 6 represents the Silent Panic Active screen. (42) The status and type of the panic is displayed in the upper half of the application screen. The user can cancel the active panic by selecting (44) the Cancel Panic button on the left of the screen. To the right of that button is (46) the Sound Alarm button. On the bottom left of the screen is (36) the Call 911 button. To the right of that button is (48) is the False Alarm button. Before canceling any “real” panic, i.e. Non-Test Panic, the user is forced to enter their correct password. See further details about the False Alarm notification at (1-J-1)
FIG. 7 represents the Loud Panic Active screen. The button options are similar except, in this case, the alarm sounds automatically when the Loud Panic is triggered, and the button option on the right side of the application screen has toggled to (50) Mute Alarm. When the user selects Mute Alarm, the alarm is silenced.
FIG. 8 represents the Medical Panic Active screen. This screen has identical button options with the Silent Panic Active screen from FIG. 6. The only visual differences between Medical Panic and Silent Panic screens are that the color and graphics on the Medical Panic screen is different from Silent Panic screen, and (42) the panic status reads, “MEDICAL PANIC ACTIVE”.
First, below, the similarities between all panic modes are listed. When any of the 3 panics are triggered, the following four actions take place sequentially:
1) The user's location is pinpointed and the map position is sent immediately to the server/website.
2a) SMS and email messages are sent to all the user's emergency contacts, to include campus security if applicable as represented by FIG. 13, and the 24/7/365 Ultimate Life Protector™ Rescue Center as represented by FIG. 14, only if the Rescue Center is ARMED. If the user has no cell phone signal when the panic is triggered, repeated automatic attempts to send the panic messages are made until adequate cell tower or WIFI signal becomes available.
2b) Within the SMS and email, a clickable web link is present with the user's own, unique web address configured. The format is http://www.LocateLovedOne.com/[UNIQUE USER NAME]. Rescuers click the link on their smartphones to view the mobile website as well as a desktop website for rescue dispatchers. This simple, logical URL format is designed to be easily shared verbally on the phone with professional rescuers.
3) Audio begins to stream from the user, directly to the server/website for rescuers to hear in near realtime.
4) A photo is taken at the moment the panic is triggered and is uploaded to the server/website.
4b) On all panic screens, buttons are available which read, “Take Photo” and “Take Video”. When pressed, if the smartphone is aimed, new photos and/or video are sent to the website.
Accessories below: (Accessories are described in detail near the end of this ULP patent description, in #6.)
5) If the user has the optional ear or head mounted bluetooth video accessory, live video from the user's vantage point streams to the website for rescuers to view.
6) If the user has the optional Pulse Monitor accessory, the user's pulse rate is displayed on the website. (Dangerously abnormal pulse readings automatically trigger a Medical panic.)
7) If the user has the optional breathing monitor, the status of the user's breathing is shown on the website. (Dangerous breathing automatically triggers a Medical panic.)
8) If the user purchased the optional brainwave monitor, (flexible cap which is densely packed with electrodes) potential brain related issues such as a seizure, stroke, blunt impact, or other issues are displayed on the website. (Serious brain related issues detected by the brainwave monitor automatically triggers a Medical panic.)
9) If the user wears the optional Automatically Activated Electrical Cardiac Resuscitation Pads, when the user's heart stops beating, the sensors recognize this, and the pads administer the correct amount of electrical impulse to defibrillate the user's heart. A medical panic is triggered. The process automatically ceases as soon as the sensors determine that a safe heart rate has been restored. The user's heart is monitored on the main home screen of the rescue website automatically, as soon as the irregular heart-related issue is discovered by the heart sensor/pads.
10) If the user is wearing the optional Transdermal Medicine Distribution patch, when a user (in consultation with her doctor) determines that essential medicine should be administered at particular times each day, the medicine is automatically administered according to the predetermined schedule. Medicine can also be withheld until a nano-blood probe determines that the user is facing a potentially deadly crisis such as a bee sting for users who are allergic to bee stings, the Medicine Distribution Patch releases epinephrine automatically after the probe determines that it is necessary. A medical panic is triggered when the probe determines that this crisis has begun.
   Further details regarding the above accessories and additional accessories are detailed near the end of this Ultimate Life Protector patent description, in #6.

### Differences Between the Three Main Panic Modes:

### Silent Panic:

When triggered, no camera flash appears, and the phone remains silent unless the user selects (46) the “SOUND ALARM” button on the application screen. If the user selects “SOUND ALARM”, a pop up appears, warning the user, “Are you sure? It will be loud.” If the user selects “CANCEL”, no alarm is sounded. If the user selects “OK”, the alarm is sounded. The user can silence the alarm by selecting (50) “MUTE ALARM” on the application screen. When Silent Panic is triggered, the user's phone ringer automatically switches to VIBRATE mode.

### Loud Panic:

When triggered, the camera flashes brightly, and a loud police siren plays from the phone's speaker, along with a voice loudly declaring, “Your pictures have been sent to the authorities.” The user can silence the alarm by selecting (50) “MUTE ALARM” on the application screen.

### Medical Panic:

When triggered, no camera flashes and no noise is made unless the user selects (46) “SOUND ALARM. If the user selects SOUND ALARM, a loud voice repeatedly declares, “Call ambulance now! Medical Emergency!”

### 1-F) Manually Trigger Silent Panic: 3 Main Methods:

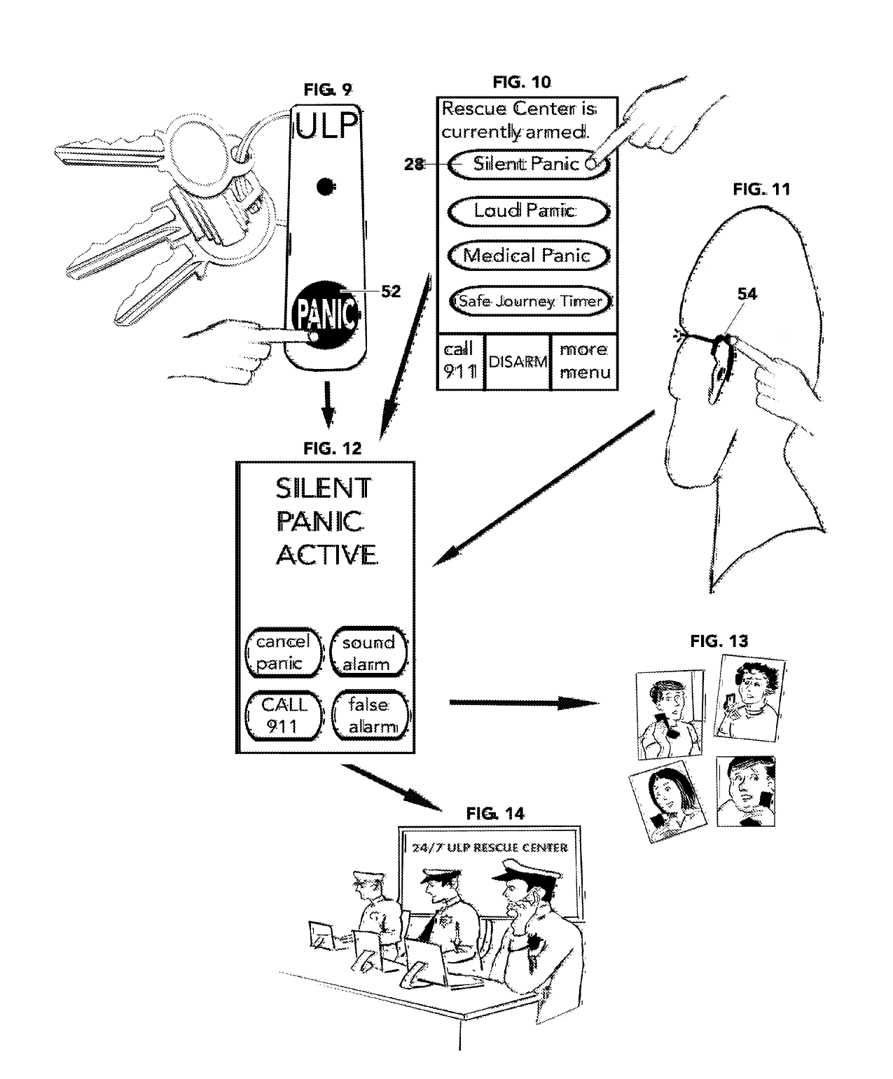

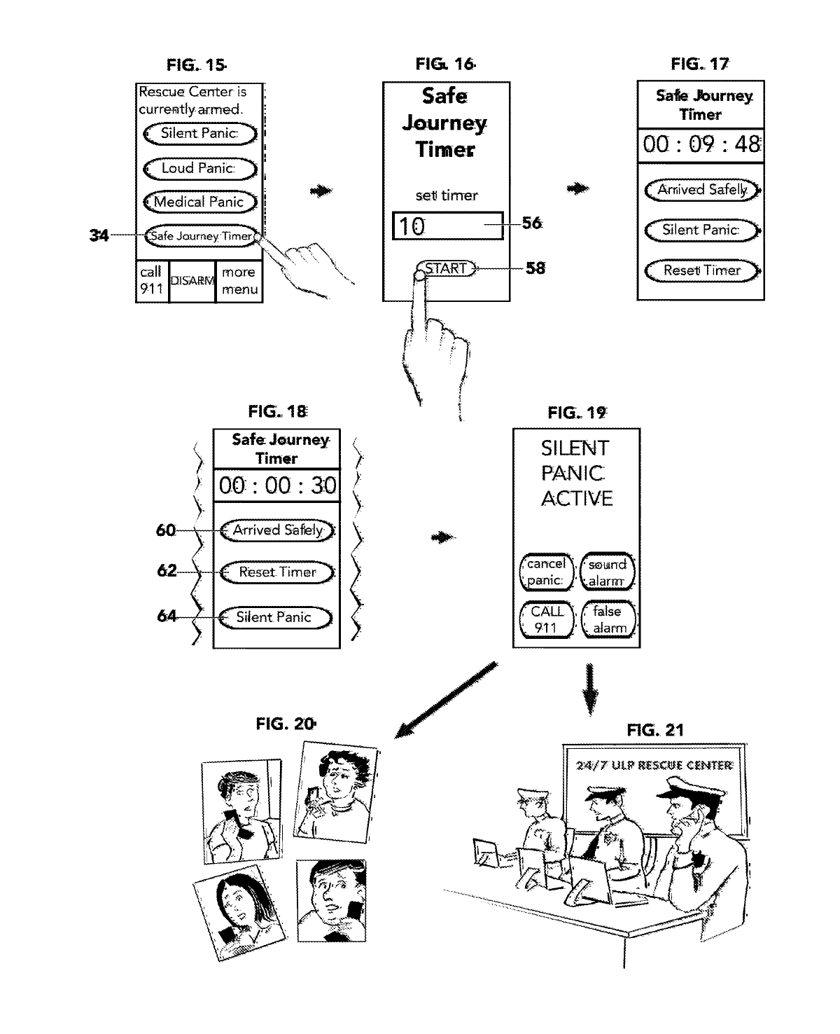

Other additional manual panic triggers are possible with the optional accessories detailed in #6.
Silent Panic is the default panic mode. Unless the user actively changes the default panic mode in the General preferences, Silent Panic is triggered when the user double clicks the bluetooth panic button, as shown in FIG. 9, example (52), double clicks the panic button on (54) the ear/head-mounted video camera as represented in FIG. 11, example (54), selects the Silent Panic button from within the ULP application as represented in FIG. 10, example (28), or triggers a scheduled panic via the Safe Journey Timer as explained below in description (1-H), and visually detailed in FIGS. 15, 16, 17, 18, 19, 20 & 21. All the sequential actions described above in (1-E) occur with Silent Panic. The user's phone makes no sound when Silent Panic is triggered, and no camera flash is seen. When Silent Panic is triggered, the user's phone ringer automatically switches to VIBRATE mode, to prevent unwanted attention directed to the user if the panic message recipients attempt to call or send SMS to the user.
If the user chooses, they can select “SOUND ALARM” from the active panic screen as represented by FIG. 6, example (46) if they wish to deter an attacker with sound of a police siren coupled with a voice declaring, “Your pictures have been sent to the authorities.” When the user first selects (46) SOUND ALARM, a pop up screen warns the user that it will be loud. If the user selects “OK”, the alarm sounds. This pop up warning appears in order to prevent the user from accidentally sounding the alarm, for instance, if the user is hiding from an attacker. The user can mute the alarm by selecting “MUTE ALARM”. The same button toggles between SOUND ALARM and MUTE ALARM, always presenting the alternate option of the mode which is currently in effect.

### 1-G) Trigger Loud Panic:

When the user triggers a Loud Panic, either by selecting it from the ULP application as shown in FIG. 5, example (30), or by choosing for Loud Panic to be the default panic in the General Preferences when one of the bluetooth buttons is double pressed, all the sequential actions described above in example (1-E) take place, but in addition to those actions, the phone's camera flash shines brightly, the audio sound which simulates the taking of a photograph with a traditional physical camera is played through the phone's sound speaker, and finally, a recording of an authentic American police siren plays through the phone's sound speaker, along with a loud voice which repeatedly declares, “YOUR PICTURES HAVE BEEN SENT TO THE AUTHORITIES”. This is meant to deter a potential date rapist, or other possible assailant whom the user believes might be deterred by this camera flash and recorded warning. In such situations, the user is advised to tell the attacker that his picture has been sent to the authorities, so he should not proceed with his illegal behavior if he wishes to avoid punishment.

### 1-H) Trigger Medical Panic:

The user can trigger a medical panic in three ways: Firstly, by selecting the option from the application screen as represented by FIG. 5, example (32), second, by choosing for Medical Panic to be the default panic in the General Preferences in which case Medical Panic is triggered when the user double clicks any of the bluetooth panic buttons such as the flagship thumb sized button represented in FIG. 22, and thirdly, if Medical Panic has been chosen as the default panic in the General Preferences, as detailed below in (1-I) below, when the Safe Journey Timer reaches zero, Medical Panic is triggered.
As with all panic modes, the sequential actions described in example (1-E) occur, and in addition to those sequential actions, the SMS and email messages, along with the rescue website, notify the rescuers that this is a Medical Emergency. If the user has certain preexisting medical conditions, rescuers can learn this key information on the website in the Medical Info section. If the user purchased any of the optional medical accessories detailed in #6, the rescuers can do any of the following on the user's rescue website: Monitor the user's pulse rate; Monitor the user's breathing; monitor the user's key blood levels, Monitor the user's brainwaves for possible seizures, stroke, blunt impact, or other electrode-detectable brain issues, determine the amount and timing of, and monitor the automatic administering of vital medicine, and monitor the activity of the automatically activated electrical cardiac resuscitation pads. (detailed in #6)
With Medical Panic, it is not necessary for the user to speak. For instance, if a user is having an asthma attack which makes it impossible for them to speak, they simply press the Medical Panic button and an ambulance will be en route to rescue the user within seconds after pressing the button. There is no need to speak or remain conscious once the panic has been triggered. If the user has a serious recurring medical condition such as asthma, the user is able to create a unique screen button of their choice, to reside on the medical panic screen. This is offered in the General Preferences, in the MORE MENU. The user can press this button to trigger the medical panic, as an additional signal to rescuers. For instance, the asthma sufferer creates an “ASTHMA ATTACK” button. If the user is unable to speak, she can press that button, instantly notifying rescuers of the nature of the emergency, without speaking. The user can create several different buttons for potential health crises which might be relevant to a particular user such as HEART ATTACK, STROKE, ASTHMA, etc.
If the user selects the “SOUND ALARM” button as represented in FIG. 8, example (46), a loud voice repeatedly declares, “CALL AMBULANCE NOW! MEDICAL EMERGENCY!”

### 1-I) Safe Journey Timer/Non-Manual Panic Trigger:

When the user begins any journey, they can activate the Safe Journey Timer as represented by FIG. 15, example (34). The user then sets the timer for the estimated time the journey will take. If it normally takes 10 minutes for a student to walk home from the library, for instance, the user sets the timer for 10 minutes as represented by FIG. 16, example (56), select the START button as represented by FIG. 16, example (58), and then they can put the phone back in their pocket while the timer counts down, as represented by FIG. 17.
When the timer reaches the final 30 seconds of the countdown, the smartphone begins to pulse vibrate for each of the remaining 30 seconds of the countdown as represented by FIG. 18. This is done to warn the user that the countdown is almost finished. If the user is safe, when the vibrations begin, the user either selects Arrived Safely to cancel the countdown, as represented by FIG. 18, example (60), or the user selects Reset Timer, as represented by FIG. 18, example (62). If, during the countdown, the user is conscious and suddenly discovers that they are facing a crisis, they can instantly trigger a Silent Panic by double clicking the physical bluetooth panic button as represented by FIG. 22, example (52), they can double click the panic button on the ear mounted video camera as represented by FIG. 11, example (54), and they can also trigger a panic by selecting Silent Panic from the Safe Journey Timer screen during the countdown, as represented by FIG. 18, example (64). If the user is unconscious or otherwise incapacitated, when the timer reaches zero, Silent Panic is automatically triggered as represented by FIG. 19, and all rescuers are alerted with SMS and email as represented by FIG. 20 and FIG. 21. As with all panic triggering, all other sequential actions are executed as described in (1-E).
Additional optional accessories detailed in #6 also contain physical panic buttons which the user can double-press to manually trigger a panic at any time, including during the Safe Journey Timer countdown.

### 1-J) More Menu:

The following options and functions reside the in the More Menu which is reached by pressing the MORE MENU button within the application:
1. QUIT ULP
2. I AM OK/Send False Alarm Message
3. Conference Call
4. Panic Message Status
5. Test Panic
6. General Preferences
7. 24/7 ULP Rescue Center
8. Add/Edit Emergency Contacts
9. Edit My Personal Info
10. Add/Edit Profile Picture
11. Pair ULP with Bluetooth Device
12. Quick Start Instructions
13. Complete Instructions
14. About ULP

### All More Menu Items Explained Below:

### (1-J-1-1-J-13)

### (1-J-1) (More Menu 1) Quitting and Canceling

Quitting Ultimate Life Protector with no active panic running:
If no panic is currently active and the user selects “QUIT ULP” from the More Menu, or QUIT at the bottom of the application screen, the application immediately quits without requiring a password.
Canceling an active panic but not quitting the application:
If the user is not quitting the application, but instead is merely canceling the active panic because they have emerged safely from a crisis, the user can select CANCEL PANIC as represented by FIG. 6, example (44). The user is prompted to enter their password. When the correct password is entered, the following pop up notification appears on the screen: “The panic has been canceled and ‘I AM SAFE!’ messages have been sent. Contact rescuers to confirm your safe status.” After the user selects OK, the pop up message disappears, the user's smartphone screen automatically displays the mobile internet browser, and the user is taken to their own rescue website where they can text and/or voice and/or video chat with rescuers and emergency contacts who were involved with the rescue. Finally, after the correct password has been entered in order to cancel an active panic, the user's phone ringer is automatically turned to the highest volume. As explained previously, when a Silent Panic is triggered, the user's phone ringer automatically changes to VIBRATE mode, for the duration of the panic. When a panic is canceled, the phone ringer volume automatically increases to maximum volume, in anticipation of likely incoming phone calls from rescuers and emergency contacts who will wish to confirm the user's safe status, so the ringer volume increase prepares the user to receive the calls.
The “I AM SAFE!” SMS message has 124 characters and reads as follows:
“I AM SAFE! Situation is now stable but it was a crisis. U can call me to confirm. If u called 911, call them & say I'm safe.”
The “I AM SAFE!” email message reads as follows:
Subject line—“I AM SAFE!”
Email body—“[FULL NAME OF EMERGENCY CONTACT]!
I am safe! My situation is now stable but this was a major crisis. Call me ASAP to discuss it, and to confirm my safe status. If you called 911, call them back and tell them I'm safe.

### [USER'S FULL NAME]

### [USER'S PHONE #]

### [USER'S EMAIL]

Learn more about this safety/rescue service and sign up yourself at http://www.UltimateLifeProtector.com.”
Quitting Ultimate Life Protector with active panic not yet canceled:
If a panic is active, the panic must first be canceled before the application can quit, and as explained above, a password is required to cancel active panics. If the user attempts to quit the application during an active panic, they are first prompted to enter their password. If the correct password is entered, the same pop up notification as above appears on the screen: “The panic has been canceled and ‘I AM SAFE!’ messages have been sent. Contact rescuers to confirm your safe status.”
After the user selects OK, the pop up message disappears, ULP application quits, and the user's smartphone screen automatically switches to the internet browser, where the user is taken to their own rescue website where they can text and/or voice and/or video chat with rescuers and emergency contacts who were involved with the rescue. As explained below in (1-J-3), the user can also start an audio and/or video conference call which can involve multiple rescuers.
Finally, after the correct password has been entered in order to cancel an active panic, the user's phone ringer is automatically raised to the highest volume. As explained previously, when a Silent Panic is triggered, the user's phone ringer automatically changes to VIBRATE mode, for the duration of the panic. When a panic is canceled, the ringer volume automatically increases to maximum volume. After the serious crisis has ended, it is no longer necessary for the user to maintain silence such as if the user were hiding from an attacker. After a serious crisis has ended, it is likely that the user's emergency contacts will wish to speak with the user, so that is the reason why the ringer must automatically increase to the maximum after the panic has been canceled, to ensure that the user doesn't miss these important calls, SMS and other communications.
User intentionally creates false impression to deceive attackers with Designated False Password:
If the user attempts to QUIT ULP during an active panic, or if the user only attempts to cancel the active panic, and they enter their DESIGNATED false password, for instance “1313”, a pop up message appears which reads, “False Alarm Messages Have Been Sent and the panic has been canceled.” Then the screen shows “ULP QUITTING . . . ”, and finally the screen switches over to the standard home screen of the smartphone. As the ULP application screens disappear from view, ALL PANIC PROCESSES CONTINUE IN THE BACKGROUND. The user's location continues to update at regular intervals, audio, photo, video and all medical data continue to stream to the rescue website, and rescuers continue with the rescue attempt.
The purpose of the designated false password relating to QUIT ULP, PANIC MESSAGE STATUS, and CANCEL PANIC functions is to deceive a potential attacker into falsely believing that the user has canceled the panic, or in the case of PANIC MESSAGE STATUS, to deceive the attacker into believing that no panic messages were ever sent. To be clear, if the user simply enters an INCORRECT password, they are prevented from canceling the panic, prevented from quitting the application, and they are continually prompted to enter the correct password until they either stop attempting to access password-restricted features, or until the correct password is entered. Only after they enter the DESIGNATED false password does the above deception take place.

### (1-J-2) (More Menu 2) “I AM OK” Message, and False Alarm Message for Accidental Panics:

If the user suddenly discovers that they have accidentally triggered a panic while they are safe, the user presses the “false alarm” button on the app screen. If the user enters the correct password, false alarm messages are sent to all contacts.
The False Alarm SMS message is composed of the following information and is sent to all contacts and, if ARMED, the Rescue Center:
“FALSE ALARM! Disregard emergency message I sent. I'm not in danger. If u called 911, call them & say I'm safe. U can call me 2 confirm.”
Concurrently, the False Alarm email message is sent to all contacts and the Rescue Center, and reads as follows:

### “SUBJECT LINE—“PLEASE IGNORE THE PREVIOUS PANIC MESSAGE”

Email body—“FALSE ALARM! IGNORE EMERGENCY MESSAGE! Please disregard the emergency message you received from me. I am not in danger. If you called 911, call them back and tell them I'm safe. Feel free to call or text me to confirm.

### [USER'S FULL NAME]

### [USER'S PHONE #]

Learn more about this safety/rescue service and sign up yourself at http://www.UltimateLifeProtector.com.”
If the user did NOT accidentally trigger a panic, but they simply wish to inform their Emergency Contacts that they are indeed safe, they select the “I am OK” button which is shown on the More Menu 2 area. When the user selects “I AM OK”, they are prompted to enter their password. If they enter the correct password, the following SMS is sent to all contacts. “I AM OK. You can call if you wish to confirm.” The following email is sent to the same emergency contacts: “Subject—I AM OK!” Email body, “[EMERGENCY CONTACT'S FULL NAME], I am OK! If you want to confirm it, you can call or text. Don't worry!

### Love,

[User's full name]”
(1-J-3) (More Menu 3) Conference Call with Multiple Rescuers:
If the user wishes, either during and/or after an active panic, if the circumstances of their crisis are such that the user is able to speak ‘out loud’ with the rescuers, the user can select CONFERENCE CALL from the More Menu, within the ULP application. After selecting CONFERENCE CALL, the user arrives at a screen which lists all of the user's emergency contacts, the Rescue Center, and the number of the nearest public rescue service to the user. Next to each contact, there is a “CALL” button. After the user has selected one contact to call, the buttons next to each remaining emergency contact changes to “ADD TO CALL”. When the user selects ADD TO CALL next to any particular contact, that contact's phone is automatically dialed and added to the conference call. When available bandwidth is exceeded, the screen displays an option to incrementally reduce the bit rate of the current phone connections, to create space for more conference call attendees. The user and rescuers can either engage in a standard audio phone call, and additionally they can engage in a video conference call if the participants possess suitable devices capable of participating in video conference calls. If only certain rescuers possess a phone capable of conducting a video conference call but other participants in the conversation do not possess video conferencing capabilities, those participants communicate with the video conferencing participants via their standard audio phone, and are able to hear all audio from the conference call.
1-J-3 In addition to the user's capability to initiate a conference call, rescuers also possess this capability via the mobile and desktop websites. On the “Emergency Contact Info” screen, as with the user's application, rescuers select a listed emergency contact and then press “ADD TO CALL”. If the rescuer's laptop or other computer is fitted with a microphone and speakers, (as with nearly all laptops), they can orally speak with several fellow rescuers. The only limitation to the number of rescuers who can participate is regulated by their available bandwidth connection to the internet. As with the user application, on the website, rescuers can incrementally reduce the bit rate of the phone communication, to create additionally available bandwidth needed to bring in more conference call attendees.

### (1-J-4) (More Menu 4) Panic Message Status:

When user selects Panic Message Status, they are prompted to enter their password. If they enter the correct password, a pop up screen appears showing whether or not the panic SMS and email messages were successfully sent. For instance, if the user is in an area with low or no cellphone signal, it is possible that the emergency messages were not yet successfully sent. In such cases, the application constantly re-attempts to send the messages as soon as cell tower or WIFI signals become available.
If the user enters the DESIGNATED false password, when the user selects Panic Message Status, a pop up screen appears which always reads, “No Panic Triggered. No Messages Sent.” This is the case regardless of whether or not the user actually has adequate cell tower or WIFI signal to send a message. It is meant to deceive an attacker into believing that help is NOT on the way, regardless of the truth.

### (1-J-5) (More Menu 5) Test Panic:

When “Test Panic” is selected from the Menu Items, the user is offered all the same panic modes as are normally present on the ULP HOME screen, but in this case, it is only a TEST version of that panic. Test Silent Panic. Test Loud Panic. Test Medical Panic. Test Safe Journey Timer. When all of these Test Panics are triggered, the functionality is identical to the non-test version of the same panic mode as detailed earlier in (1-E), (1-G), (1-H) and (1-I), except for the following differences:
A) Instead of the standard SMS panic message, the following SMS panic message is sent to the emergency contacts, but not to the Rescue Center, and this message contains the same unique clickable web link to locate the user:
“Only a TEST. If I were in true danger I'd need you 2 call 911 & tell them 2 locate & rescue me @ http://www.LocateLovedOne.com/[UNIQUE USER NAME]
B) Instead of the standard email panic message, the following email is sent to all emergency contacts, but not to the Rescue Center:
Subject—“TEST PANIC from [USER'S FULL NAME]”

### Email Body—“Hello [NAME OF EMERGENCY CONTACT],

This email is a test panic message from my rescue system called Ultimate Life Protector™. THIS IS NOT AN EMERGENCY. If this were a real emergency, I would need for you to immediately call 911 and tell them to locate and rescue me at the following website below. You can click on it now to learn my location, hear audio, among other resources which could be used in a real emergency. Please explore the website so you can learn how you can help during an emergency.
http://www.LocateLovedOne.com/[UNIQUE USER NAME]
Thank you for agreeing to help me if I'm in danger!

### [USER'S FULL NAME]

### [USER'S CELL PHONE NUMBER]

### [USER'S EMAIL ADDRESS]”

C) Even if the Rescue Center is ARMED, when the user triggers any panic from the TEST screen, no TEST PANIC messages are ever sent to the Rescue Center.
D) If the user selects TEST Safe Journey Timer, the timer works as normal, but if the countdown reaches zero, the above TEST panic messages are sent to the emergency contacts. Not to the Rescue Center.

### (1-J-6) (More Menu 6) General Preferences:

The user can view and alter the general preferences by selecting “General Preferences” from the MORE MENU within the ULP application:
A) Screen sleep can be disabled during ULP use, to keep the ULP screen at the ready by deactivating screen sleep at the top of the General Preferences. In this case, the screen dims, but remains on, so that when the user simply taps the screen once, the brightness returns to the previous brightness setting. This allows the user to tap LOUD PANIC on the app screen whenever the user has the need to deter an attacker, such as a date-rapist, for instance. With the screen sleep disabled, the user is not required to awaken the screen and unlock it before selecting LOUD PANIC, or any other panic available on the screen.
B) Default mode is for a pop up screen to appear after the ULP application has been running for 60 minutes, to remind the user that ULP is still running. If the user is safe, they can quit the application. This notification can be deactivated in General Preferences.
C) Default mode is for location pings to send every 30 seconds during normal use. When the battery runs below 20%, Low Battery Conservation Mode takes effect, which restricts location pings to once every 3 minutes. Also, when Conservation Mode is in effect, the screen sleeps when the user is not using it, regardless of the screen sleep setting above in (A) The user can deactivate Low Battery Mode in the General Preferences. If deactivated, pings continue to send every 30 seconds until the battery depletes fully.
D) Default mode is for Safe Journey Timer to NOT require a password to cancel the countdown, when the user safely arrives at their destination. If the user wishes to require that the correct password be entered before canceling the Safe Journey Timer countdown, they can choose to require a password in the General Preferences.
E) The default emergency service phone number is 911. For users in countries other than the U.S. with different government emergency phone numbers, (such as 999 in the UK) users can enter the appropriate emergency phone number at the bottom of the General Preferences.
F) The default panic is Silent Panic. If the user chooses, within the general preferences, they can select a different panic to trigger as the default. For instance, a user with a severe heart condition might choose Medical Panic as default. In this case, if the user double presses any available panic button, Medical Panic is triggered, and if the user is wearing the optional pulse monitor accessory, for instance, medical professionals can monitor the user's pulse before they arrive on the scene. As an example of setting Loud Panic to be the default panic, a teen age girl can set Loud Panic as default before attending an unchaperoned party, to deter potentially intoxicated and aggressive males.
G) The user can create custom buttons for the app screen, which describe anticipated crises. For instance, if the user suffers with a serious asthma condition, in these preferences, users are able to create a custom “ASTHMA ATTACK” button which appears on the screen. If the user is unable to speak during an asthma attack, they can press this button, instantly notifying rescuers of the nature of the emergency, without speaking. The user can create multiple buttons for several possible crises such as “PEANUT EXPOSURE” “BEE STING”, “STROKE, etc.

### (1-J-7) (More Menu 7) 24/7 ULP Rescue Center—Menu Options:

A predetermined SMS-capable phone number and an email address for the Rescue Center appears by default in the Ultimate Life Protector™ application, in the MENU ITEMS. When new software versions of ULP are released, if the Rescue Center phone number and email has changed, the new contact info is updated into the software. To be clear, ULP has established the correct cell phone number and the correct email address with which the user can contact the provided Rescue Center. This contact info is automatically present within the software, and if any contact info relating to the Rescue Center changes, the software is be automatically updated to include these changes, so the Rescue Center always receives panic messages while the Rescue Center is armed.
CHANGING RESCUE CENTER INFO: It is also possible, although caution is urged, for the user to alter the emergency phone and email address. One situation where it might be appropriate for users to decide to alter the Rescue Center contact info would be for a college student who has 24/7 campus security available. The user can insert the contact info for her specific campus authorities, so when her Rescue Center is armed, campus security is dispatched to rescue the user.
When the user triggers their very first TEST panic after signing up for the service and entering emergency contact info, an invitation email is sent to all the new emergency contacts. In the aforementioned case of a college student, campus security receives the invitation email, the security service communicates with the user, and understands how to take advantage of ULP rescue features to rescue the user if campus security receives a REAL panic message from the user.
If the user determines her situation is such that she is able to orally speak with the Rescue Center during a crisis, (not applicable for “Lite” users) she can call the Rescue Center directly by simply pressing the “CALL RESCUE CENTER” button in the MENU ITEMS, on the 24/7 ULP Rescue Center screen. In such cases, the Rescue Center talks to and comforts the user while arranging for the rescue to proceed.
The details of the Rescue Center protocols for rescue personnel are explained later in this document, in #5.
For users who sign up for so-called “Lite” service, the Rescue Center described above is not available, but the user is offered the ability to enter contact info for a Primary Rescuer. In cases where college students have 24/7 security available on their college campus, for instance, “Lite” users can enter contact info for their campus security.
If the “Lite” users DISARM the Primary Rescuer, when the user triggers a panic, only the Emergency Contacts can receive the panic messages. When the Primary Rescuer is ARMED, the Designated Primary Rescuer receives the panic messages. This DISARM function allows Lite users to trigger panics in non-dangerous situations, such as to be liberated from an unpleasant conversation at a party. If the user plans to use the panic in such a non-dangerous situation, the emergency contacts must be notified in advance, so it is not treated as a life-threatening emergency which requires public rescuers. When Lite users ARM the Primary Rescuer, for instance, if the user has a known severe medical condition, they can enter their doctor's contact info in the “Primary Rescuer” field, it is understood by the panic message recipients that the user has declared that he is in serious danger. Many intended uses for the DISARMED mode during non-dangerous situations are detailed earlier in (1-C)

### (1-J-8) (More Menu 8) Add, Edit Emergency Contacts:

When the user first installs Ultimate Life Protector™, they are prompted to enter the cell phone numbers and email addresses of their family and close friends, who the user determines as the best people to receive panic messages if the user triggers a panic, and act to rescue the user in such circumstances. Here, in the MORE MENU, the user can add additional contacts to the list, and edit the existing contact information whenever they wish.

### (1-J-9) (More Menu 9) Edit User Personal Information:

When the user first installs Ultimate Life Protector™, they are prompted to enter their own key information, so it can be available to rescuers in case of emergency. Users can update this information at a later date from the More Menu. The information which the user is prompted to enter is as follows:
a) Full name
b) Home address
c) Email address.
d) Cell phone number.
e) Any pertinent medical information which could be useful to rescuers such as blood type, allergies to particular medications, bee sting allergies, asthma, etc.

### (1-J-10) (More Menu 10) Add/Edit Profile Picture:

When the user first installs Ultimate Life Protector™, they are prompted to take a picture of themselves with their phone. This user photo is displayed on the rescue website, so rescuers will be able to identify the user during an emergency. After the user takes the picture, before submitting it to the ULP server, they are able to view the picture, to determine if it is suitable. If the user wishes, they can retake the picture until they are satisfied.
Here in the More Menu, users can return to the user photo section, to take a new picture of themselves. When the user is satisfied with the new picture, it is uploaded to the rescue website. For smartphones which include a self-facing camera, where the user can view themselves in the smartphone screen while taking the picture, this mode is automatically used when such a self-facing camera is present, and when the user arrives at the user photo screen via the More Menu, the existing user photo is displayed. If the user selects “Take A New Photo”, the screen changes to become a live viewfinder, and when the user selects the “Snap Photo” button, the photo is taken. The most recent photo of the user remains on the screen. If the user is unhappy with that picture, the user can select “Take A New Photo” again. Once the user approves of the photo, they select, “Upload to Website”, and the user photo is sent to the website, and the ULP application screen returns to the More Menu.
For users with smartphones which do not include a self-facing camera, the main camera on the phone is used. A pop up screen appears which reads, “It's easiest to take your photo in front of a mirror, so you can see the phone's screen in the mirror. This way, you can make sure your face is centered.” The user can select OK to close this popup window. “When the user selects “Snap Photo” from the screen, the new photo is taken. All button options are the same with the self-facing camera and the forward-facing-only cameras. Once the user uploads the approved photo, rescuers can see this photo on the user's website whenever a panic is triggered.
(1-J-11) (More Menu 11) Pair with Bluetooth Accessories:
When the user arrives at the “Pair with bluetooth accessories” More Menu option, the user is prompted to prepare all related bluetooth accessories for pairing. This is done by placing the devices in “pairing mode”. Once the accessories are findable, the ULP smartphone application locates and pairs with the devices. Once the devices are paired for the first time, the smartphone always recognizes these accessories whenever the accessories enter the bluetooth range of the smartphone. In most cases, this range is within 15-30 feet.
These accessories which can be paired with the user's smartphone are listed below. Further details about the accessories are explained later in this document, in (6).
main bluetooth panic button with clip, snap button and keychain hole (#2)
ear-mounted video camera with panic button (#6-A)
pulse monitor bracelet with panic button (#6-B)
brainwave monitor (#6-C)
breathing monitor (#6-D)
Large Dose Medicine Distribution Chamber (#6-E)
Automatically Activated Electrical Cardiac Resuscitation Pads (#6-F)
nano probe blood monitor (#6-G)
Wireless Magnetic Charging & Blood Probe Interface Pad (#6-H)
Transdermal Medicine Distribution Patch (#6-I)

### (1-J-12) (More Menu 12) Quick Start Instructions:

These brief instructions direct the user to experiment with the Test Panic function, and broadly explain what ULP does, and how it works. It provides the user with a basic overview of the system, and contains key information needed to begin learning more about ULP, crucially WITHOUT contacting the Rescue Center.

### (1-J-13) (More Menu 13) Complete Instructions:

Detailed instructions via text, images and video which demonstrate the many ULP features and functions are offered here. Users are provided with a web link which they can use to view the instructional videos, text and images on their desktop and laptop/tablet computers, for easier viewing. Within the instructions, an invitation is offered for users to join a blog where different users can communicate with each other, answer questions, and maintain a ULP community. A ULP webmaster monitors the communications and provides solutions and insights to the user members. Users are also offered an email address where they can send their queries directly to Ultimate Life Protector, LLC, and also a phone number for verbal technical assistance.
(1-J-14) (More Menu 14) about ULP:
The mission statement and contact info for the ULP company appear here. Frequently asked questions are listed here along with answers. A web link is provided to the ULP sales and company website which is a completely different website from the Rescue Website.

### 2. Main Bluetooth Panic Button:

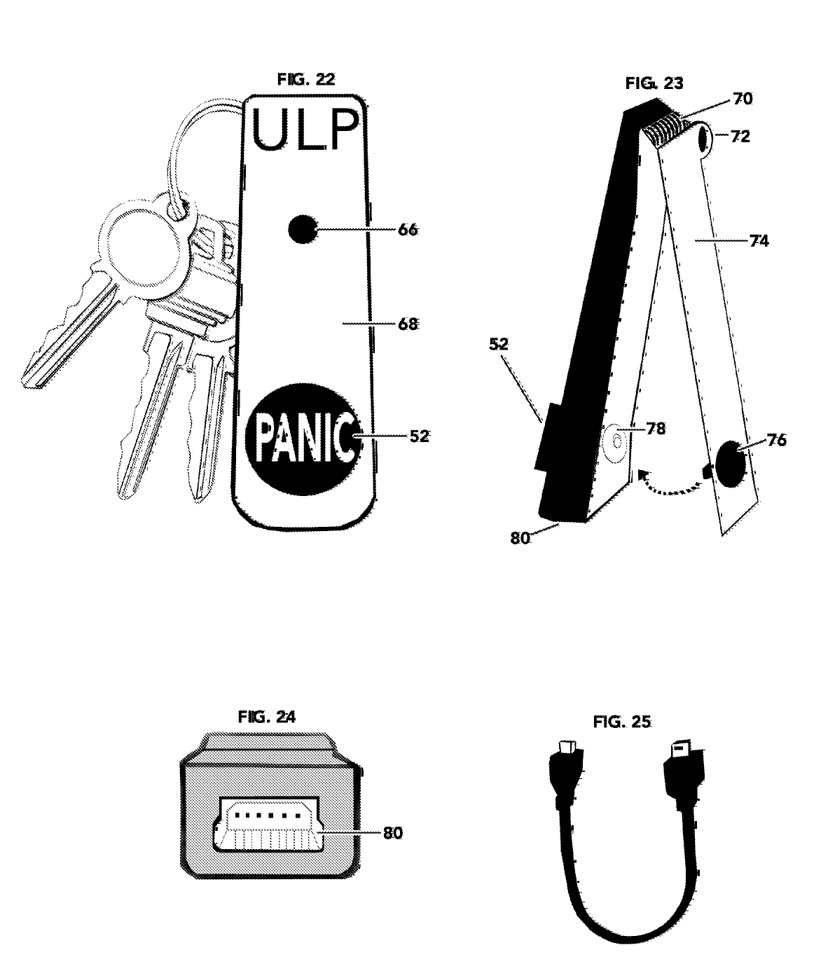

Thumb sized, rechargeable, portable bluetooth panic button. This button is designed to be the “flagship” panic trigger device for most users to have as their primary panic trigger button with ULP.
The device as shown in FIG. 22, is designed to be highly portable, so it is not longer than 2.75 inches in length. As shown in FIG. 22, example (66) a small LED is present in the center of the panic trigger device. When the battery needs recharging, in addition to other actions described below, the LED blinks with a red light continuously until the user recharges the device. When the user successfully pairs the bluetooth device with their smartphone, the LED (66) flashes with a green light for several seconds. The panic “trigger” is shown in FIG. 22, example (52). This panic trigger, aka button is the only button on the front of the device, so the user is never confused as to which button to double-press during an emergency. There is only one.
The device contains several physical options with which the user can attach the device to their person. As shown in FIG. 23, a metal clip is attached to the rear of the device, allowing the user to clip it to their belt, pocket, shirtsleeve, pocketbook strap, backpack strap, or anywhere else a clip can be attached. As shown in example (70), a tightly wound spring resides at the top of the clip, exerting constant pressure to close (or seal) the clip. As shown in examples (76) and (78), a “snap button” is present at the bottom of the clip. Example (76) is the male snap button, and example (78) represents the female snap button, which abuts the bluetooth device. The user can insert thin clothing in between the button snaps, and then snap the button closed over the user's clothing. This firmly attaches the device to the user's clothing. A user can snap the button closed at the wrist area of their shirtsleeve, for instance, and the device will remain securely in place, and always readily available to trigger a panic. Another option is for users to insert a pocketbook or purse strap in-between the clip and close the button snaps. The device can be firmly attached to the pocketbook strap, backpack strap, or other object which the user always tends to have with them.
If the clothing material is too thick to enable the button snaps (76) (78) to close, for instance if clipped to the waist of a user's denim jeans, the device remains relatively firmly in place because (70) the tightly wound spring exerts constant pressure to close the clip.
As shown in FIG. 23, example (72), the metal clip also contains a hole which the user can attach to their keychain.
As shown in FIG. 24, example (80) a female USB port is present at the bottom of the device. This port is primarily used to recharge the device by connecting it to a computer or other USB charging station with a standard male-to-male USB cable as shown in FIG. 25. In addition to recharging the battery, this USB port can also be used to upgrade the firmware of the device if and when company officials create and distribute improvements to the firmware to the users.
The user pairs the button with their smartphone once, and after this precedent, the smartphone and bluetooth device permanently recognize each other every time the smartphone enters the range of the bluetooth signal, enabling the smartphone to rapidly receive and act upon panic signals sent to it by the bluetooth panic device. Unlike a variety of smartphone “apps”, with the tiny, portable ULP button, the user can instantly trigger a panic at all times, without causing a potential attacker to notice. This is achieved because the button is intended to be attached to the user's clothing and/or purse or item which the user is constantly in close proximity to, such as a shirtsleeve and other places detailed below. A variety of smartphone “apps” exist intending to notify loved ones and rescuers that a crisis has begun, but mere “software applications” do not contain a PHYSICAL, portable, conveniently accessible trigger mechanism. Instead, applications require the user to access the app within the user's smartphone interface.
If it is necessary for the user to access the smartphone interface when it has suddenly become apparent that the user is facing a life-threatening crisis, when the crisis begins, mere apps without portable panic buttons unrealistically require the user to 1. Retrieve their phone from their pocket, 2. Awaken the screen 3. Unlock the screen. 4. Locate and launch the “app”. 5. Trigger a panic, With the Ultimate Life Protector Button, the user instantly and discreetly double-clicks the panic button at the very moment when the user first determines that they are in serious danger.
If an attacker suddenly appears, for instance, in the back seat of a car after the user has returned with groceries, it would be impossible for the user to instantly retrieve their phone from their pocket, awaken the screen, unlock the screen, locate an application, launch an application, etc. The crisis would appear instantly, and a tiny, portable button which is always attached, for instance, to the user's shirtsleeve, would always be discreetly and instantly accessible to the user in nearly all circumstances.
To trigger a panic with the button, the user double-presses (52) the panic button. It is not necessary to power the device on first, before pressing the panic button. This and other power related details are explained below. When the button is double-clicked, a panic signal is sent to the pre-paired smartphone. Double-press (aka double-click) is a necessary requirement to prevent most accidental panic triggers. If the user sits on the button, for instance, a panic will not be triggered. Only when the button is double-clicked is the panic triggered. Once the panic signal is successfully received by the smartphone, (68) the bluetooth device vibrates. This vibration serves as confirmation that the panic has been successfully triggered. With this feature, the user can be discreetly reassured that professional rescuers are on the way, without alerting a potential attacker.
The panic button (52) on the device is designed to be felt with the user's fingers, without looking at the button. In other words, the device can be attached to the user's belt, and the user can FEEL the button (52) without looking at it, because it sticks out (protrudes) and is tactile for the user's finger, so they can locate it and double press it to trigger a panic discreetly, without the user needing to turn their head to look at the button, so it can be pressed discreetly, without a potential attacker noticing. When the user double-presses the button, (52) the button is physically designed so that the button-press “CLICKS” in a tactile, noticeable way. In other words, when the user presses the button, a click is felt by the user's fingers, so they can be aware that the button has been successfully pressed.
Crucially, unlike other portable devices, the Ultimate Life Protector™ bluetooth device is designed to be smaller than a standard adult thumb size. No longer than 2.75 inches. This is essential to enable its convenient attachment to any desired part of the user's clothing, for easy and constant access to the device in case of emergency. Other devices are too bulky because of their decision to house GPS and other power and size-intensive features on their primary triggering device, making it impossible to attach such larger, phone-sized devices to a shirtsleeve, for instance.
This small size of the ULP panic TRIGGER device is only possible by restricting the functions which are physically available on the panic device to only be the TRIGGER mechanism, NOT the rescue “system”. In other words, by only using the small, portable TRIGGER device as a panic button, it is not necessary to house the essential ULP features (such as GPS, internet capabilities, speaker, microphone, etc.) on the trigger device because all those vital functions are ubiquitously available on the user's smartphones, and harnessed through the ULP software application. An additional advantage to housing the aforementioned features on the phone rather than the trigger device is so, if a potential attacker notices the trigger device, they can seize it, and destroy it, but this will not interfere with the rescue, because the location, audio and other data continue to stream from the user's smartphone, which remains hidden in their pocket or purse during the entire crisis. In short, attackers will be most likely to notice and destroy or throw away the trigger device, but after the panic has been triggered, there is no longer any need to posses the trigger device for the rest of the rescue.
Other portable rescue devices commonly possess the array of features listed below, which are physically present on their panic trigger device, causing such devices to be large, impossible to attach to clothing, expensive, and consume a great deal of power relative to the bluetooth button described herein. Crucially, if a potential attacker notices and destroys a rescue device which contains the resources necessary for rescuers to understand the crisis and locate the user, rescuers will lose the ability to rescue the user. The sole imperative of the ULP bluetooth button device is to send a panic signal to the user's smartphone. Ultimate Life Protector™ accesses all the features below and more from within the Ultimate Life Protector™ application which resides on the user's smartphone.
The following capabilities, among others, are used by ULP via the smartphone, but unlike existing rescue alert systems, are NOT housed within the Ultimate Life Protector™ panic trigger device:
GPS
SMS and email capabilities
two-way verbal communications capabilities
graphical screen interface
mobile internet capabilities
text input interface such as keyboard
audible speaker
microphone

### Unique Power Solution:

The Ultimate Life Protector™ panic button is designed to permanently remain in a deep hibernation, regarding the power. To be clear, this means that the device is never powered off. It is always powered on, at an extremely low level of power usage, only using the power needed to maintain a running clock. The device is always in a deep sleep. When the user double clicks (52) the panic trigger button, the following sequential events begin:
a) The device fully powers on.
b) The device sends a panic signal to the pre-paired smartphone via bluetooth.
c) The device vibrates when it receives confirmation from the smartphone that the signal has been successfully received. This vibration informs the user that the panic has been successfully triggered.
d) The device reenters deep power hibernation.
   Roughly every 2 weeks, the device is scheduled to automatically power itself fully on, to run a self-diagnostic process to assess the current state of the power supply. If the diagnostic process determines that the battery contains more than 20% remaining battery power, the button reenters deep power hibernation. If the button contains less than 20% remaining battery power, the device does NOT reenter power hibernation, and the LED light at the top of the device constantly blinks brightly with a red color, to notify the user that the battery is running low, and the device must be recharged.
   In other words, when the diagnostic test determines that the battery is low, the device does NOT reenter deep power hibernation, which is the default mode. Instead, because the device has less than 20% available power, the device remains powered fully ON, indefinitely, and the LED blinks RED for several days, reminding the user that the button needs to be recharged. Finally, if the diagnostic test reveals that the battery has reached less than 20% remaining power, the panic button device sends a signal to the user's smartphone, instructing the smartphone to send an email and SMS to the user, reminding the user that it is time to recharge their panic button device. After the panic button has been fully charged, a different SMS and email message is sent to the user, notifying them that the device is now fully charged.
   This deep power hibernation solution enables the device to function without recharging for several months. Without the hibernation solution, the user would be forced to remember to power the button on when they want it to be ready to trigger a panic in case of emergency. Without the hibernation solution, when the user leaves the house, for instance, they must remember to power the device on, and they must keep it on for the majority of the day, causing it to use drastically higher amounts of energy.
   Under such conditions, it would be necessary for the user to recharge the device every 2 or 3 days. Also, under these conditions, if the user forgets to power the device on when leaving the house, and the user unexpectedly finds themselves facing a dangerous crisis, the user would be forced to power on first, and then to trigger the panic. That might be difficult to do if the user is under duress. Finally, under these conditions, the number of instances when the battery dies, rendering the panic button useless during a real crisis greatly increases. This is a fact because, with the hibernation solution, the button is available and ready for use for several months at a time, and the user must only be prompted to recharge the device 4 or 5 times per year. Without this hibernation solution, the user must remember to recharge the device almost daily, exponentially increasing the likelihood that the user will neglect to charge the device before they face an unexpected crisis.
   With the deep power hibernation solution, the user simply brings the device with them. There is no need to “prepare” the device before it is available to trigger a panic. The user does not ever “turn on the power”. Instead, the user brings the device with them at all times, and if the user finds themselves in a dangerous crisis, they double-press the panic button, which powers on the device and triggers the panic.
   This power hibernation solution is intended to enable the user to largely ignore the existence of Ultimate Life Protector™ panic button, with negligible maintenance, yet it is always available to them if and when they need it.

### 3. Scalable Server:

A web server is commissioned and configured to facilitate data exchange between the user, loved ones, the 24/7/365 Rescue Center (detailed in #5) and a dedicated mobile/desktop website. (detailed in #4) The server capacity is predetermined to be instantly and automatically expandable, so that a sudden increase in web traffic causes an automatic transfer of the necessary resources to increase server capacity sufficient to always serve the increased demand.

### 4. ULP Rescue Website:

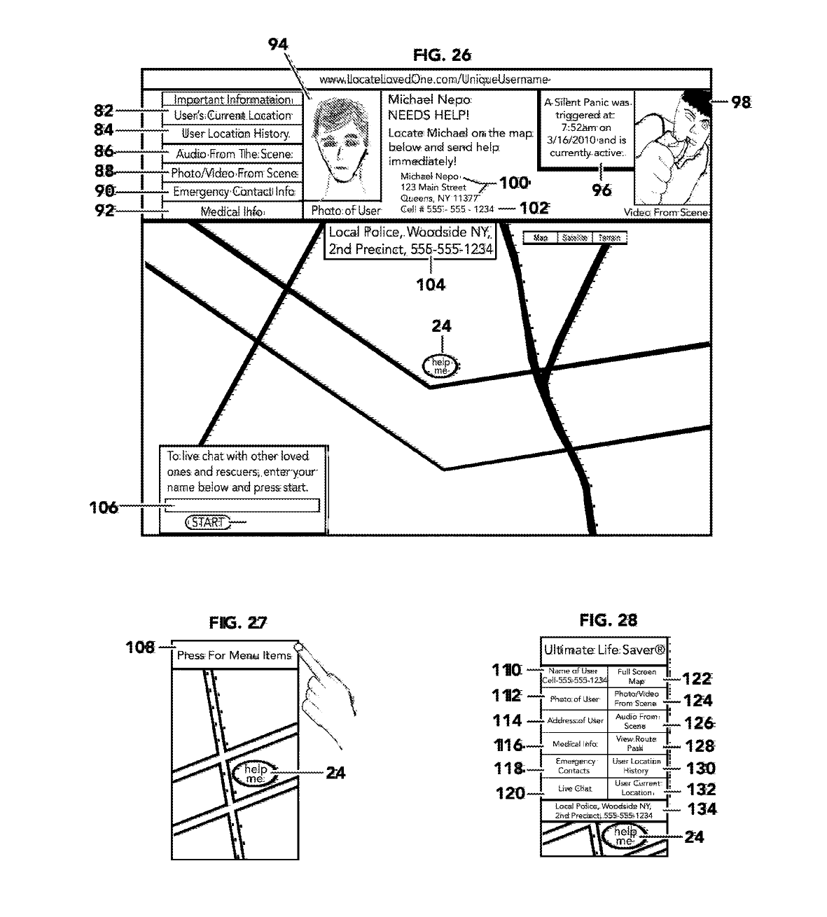

A dedicated mobile and desktop website serves as the central data clearinghouse, where all data useful in facilitating the user's rescue is available to rescuers and loved ones. When the user triggers any panic, all registered loved ones and the 24/7/365 Ultimate Life Protector™ Rescue Center (detailed below in #5) receive an SMS and email nearly instantly, indicating that the user is in grave danger.
Inside the SMS and email, the individual user's own unique clickable web link is automatically provided. As shown at the top of FIG. 26, the user's unique web link brings them to the rescue website. The format for all user web links is as follows: “www.LocateLovedOne.com/[UNIQUE USER NAME]”. All who receive the message with the embedded clickable web link simply call either 911, or they can also call the nearest governmental rescue precinct to the user if the user is in an area where the worldwide local database of governmental rescuers provides for the user's particular location, to instruct them to visit the user's website.
In other words, the ULP database of local governmental rescue precincts, such as police and ambulance services, can provide the panic-message-recipient with the nearest police and ambulance contact info, shown in FIG. 26, example (104).
If the panic message recipient lacks access to the internet, the message recipient/rescuer can simply call 911, and instruct 911 to view the user's unique web address, because the user faces potentially mortal danger. Emergency contacts explain to the 911 operator that all ULP users understand that triggering a panic is an indication that they face mortal danger, and that they need to be rescued immediately.
Once professional rescuers have been rapidly notified of the crisis, and are given the user's unique web link, with their own smartphones and desktop or tablet computers, all rescuers are instantly armed with the following array of data points which can be used to rapidly facilitate the user's rescue from any number of dangerous crises, detailed in the Website Data section below:

### Website Data Below: (4-A-4-t)

### 4-A) User's Current Location:

As shown in FIG. 26, example (24), the user's location appears in the center of the desktop website as a brightly colored icon labeled “HELP ME” which appears in the center of the map. The mobile website with the same information is shown in FIG. 27, example (24). Every 30 seconds, when the user's location is updated, the HELP ME icon moves to the user's updated position. If the rescuer accidentally scrolls away from the (24) HELP ME icon on the map and loses track of the icon, they select “User's Current Location” on the desktop website, as shown in FIG. 26, example (82), and on the mobile website, as shown in FIG. 27, example (108) after selecting the “Press For Menu Items” button at the top of the mobile screen, the mobile website Menu Items are shown, as shown in FIG. 28, example (132) from the website Menu Items. When this button titled “User's Current Location” is selected, the HELP ME icon centers on the map.
On both the mobile and desktop/tablet websites, when the rescuer selects “User's Current Location” from the available button options, the HELP ME icon shifts to the center of the map, informing rescuers of the user's current location.

### 4-B) Local Emergency Dispatch Database:

A comprehensive database is used which contains contact info for all LOCAL, professional, governmental emergency dispatchers, which data are stored on the dedicated Ultimate Life Protector™ server, for all localities worldwide. After the user's location has been determined during a panic, the nearest governmental rescue precinct contact info is gathered from the server, and the phone number for that local precinct is displayed on the website, at the top of the map, as shown in FIG. 26, example (104). Loved ones and the 24/7 ULP Rescue Center immediately contact the local governmental rescue dispatcher, nearest to the user, when they arrive at the website, after the panic has been triggered.

### 4-C) User's Location History:

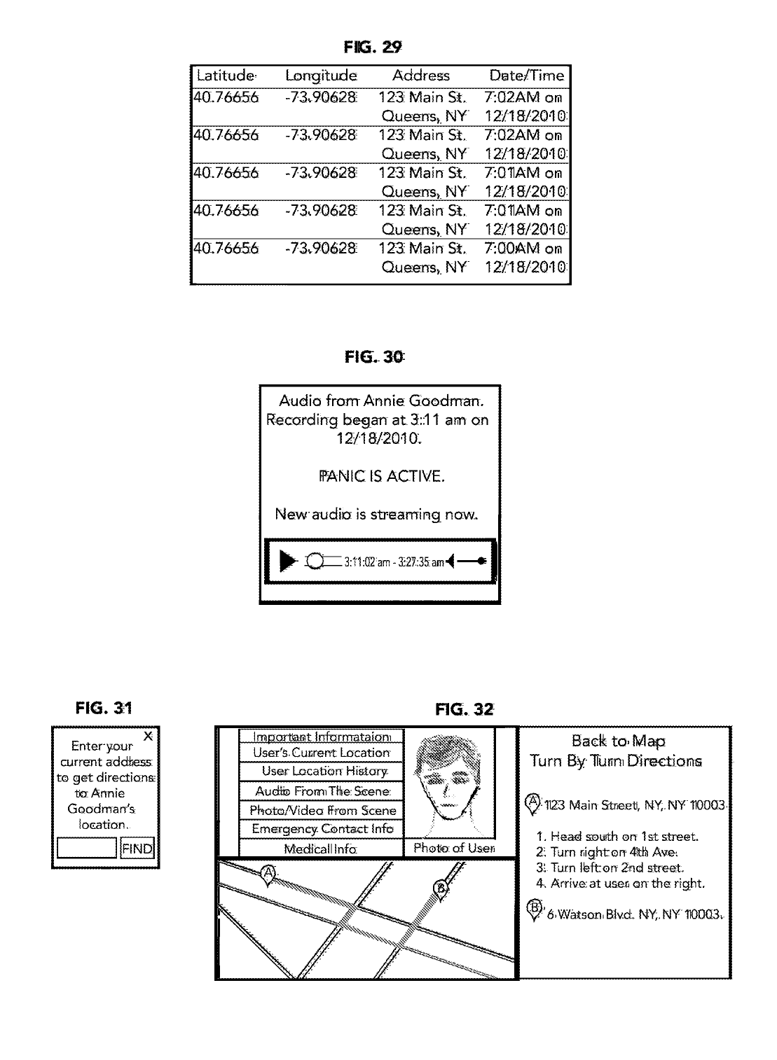

When rescuers select “User Location History” on the mobile and desktop websites, as shown in FIG. 26, example (84) and FIG. 28 example (130), a screen appears which shows the user's previous locations, in 30 second increments. An approximate street address and the latitude/longitude coordinates for the user's location are shown with each data ping, as shown in FIG. 29.

### 4-D) User's Previous Route Path:

Rescuers are able to see colored lines on the map which represent the user's past movements, beginning when the panic was first triggered. On the mobile website, as shown in FIG. 28, example (128) the user selects “View Route Path” from the Menu Items, and the colored lines appear on the map. On the desktop website, the colored lines representing the user's previous movements appear on the map automatically. These colored lines are easily seen on the website, but impossible to see in black & white drawings.

### 4-E) Audio:

When any panic is triggered, audio is recorded live from the user's smartphone, and the audio signal is streamed to the website. Each separate audio recording is listed with the time and date of the audio recording. Rescuers can listen in near realtime to audio from the scene of the crisis, by selecting Audio From The Scene on the desktop website, as shown in FIG. 26, example (86) and on the mobile website as shown in FIG. 28, example (126). When the rescuer selects the Audio from the websites, they view all listed audio files with the time and date shown. When the rescuer selects any of the displayed audio files on the mobile and desktop websites, the audio player appears as shown in FIG. 30. The audio counter on the audio player appears as a clock. This enables listeners to note the time of day when each moment of the audio recording took place, which can provide invaluable data to investigators, both during and after the crisis. When the rescuer rewinds the recording, the clock also rewinds, showing the time when that portion of audio took place. Rescuers are able to listen to the near-live audio as it continues to stream, and are also able to rewind to earlier portions of the recording, as new audio streams. The rescuer can return to the most recent, near-live audio by forwarding to the end of the available recording. From there, near-live audio continuously streams as long as the panic remains active, onto the rescuers mobile smartphone, tablet, desktop, laptop or any other internet-enabled computer.

### 4-F) Directions to the User:

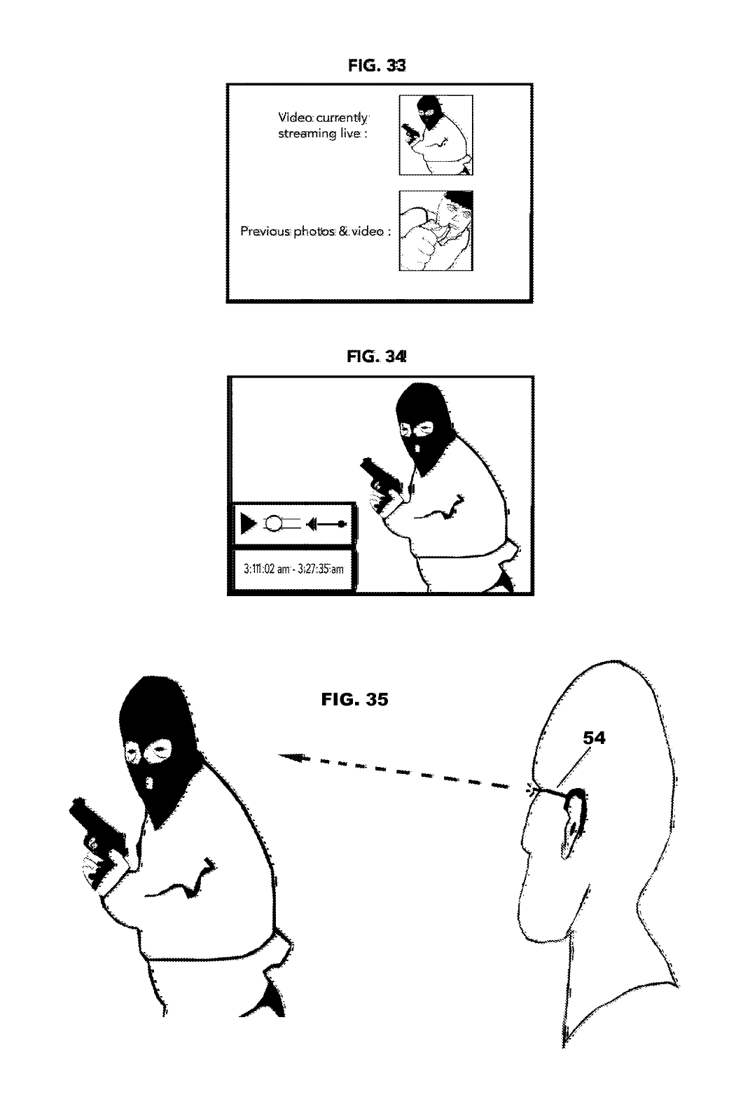

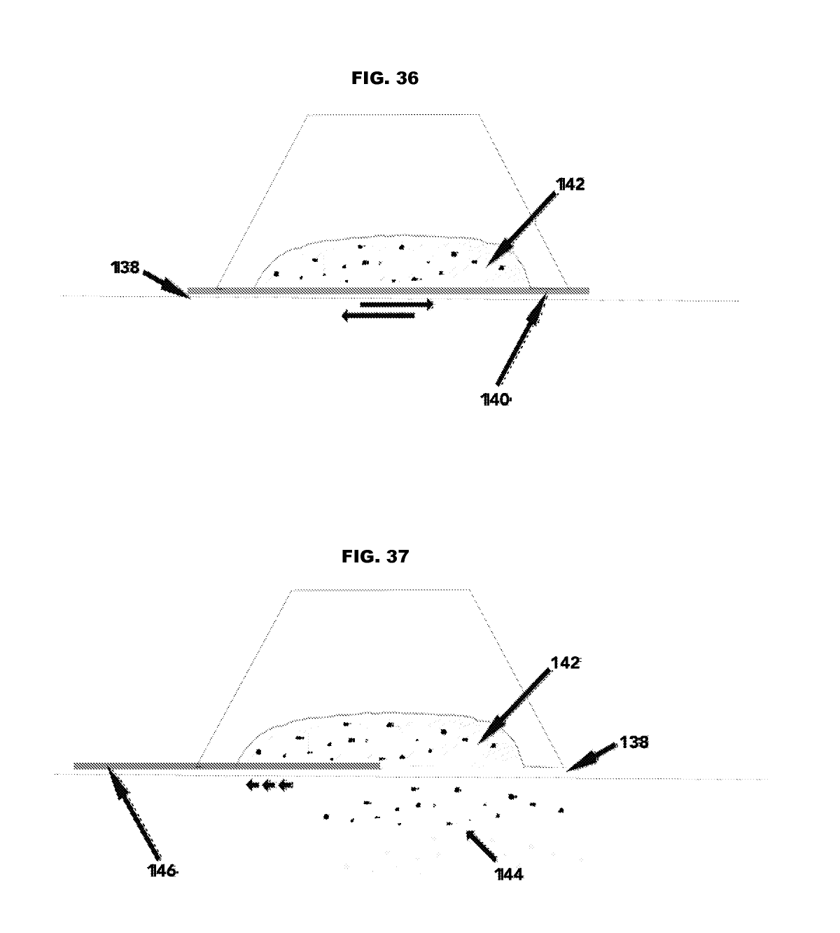

All rescuers and emergency contacts can instantly get directions to the user's location. Rescuers simply select/press the HELP ME icon on the map as shown in FIG. 26, example (24). A blank address-field appears after the HELP ME icon is pressed, as shown in FIG. 31. The rescuer enters their own current address, and the user is provided with turn-by-turn directions to the user's current location, as shown in FIG. 32. Colored lines on the map represent the suggested route to the user. These colored lines are easily seen on the website, but impossible to see in the submitted black & white drawings and screenshots.
4-G) Photo/Video from the Scene:
When the panic is first triggered, the user's smartphone takes a photo and sends it to the website. If the user possesses the optional ear mounted video accessory, rescuers can view near-realtime video from the user's vantage point. The video signal is transmitted from the ear-mounted device via bluetooth to the user's smartphone, and the smartphone streams the video to the mobile and desktop websites.
When the rescuer selects “Photo/Video From Scene” on the mobile and/or desktop websites, if video and/or photos are available, they are displayed as thumbnails, as shown in FIG. 33. When the rescuer selects one of the available video thumbnails on either website, the video player screen appears, as shown in FIG. 34. On the desktop website, if the user has streamed video in a panic, the streaming video automatically appears in the upper right corner of the website, as shown in FIG. 26, example (98).

### 4-H) Ear-Mounted Audio/Video Camera:

If the user possesses the optional ear-mounted audio/video accessory, rescuers are able to view near realtime video, from the user's precise vantage point. This is achieved by providing a small, ear-mounted video accessory. The camera lens is roughly the width of a paper clip, and it is designed to jut out in front of the user's ear, pointing directly forward. The device snugly adheres to the wearer's ear. This camera angle provides rescuers with the user's vantage point, which greatly enhances the rescuer's understanding of the user's predicament.
In addition to the audio and video, the ear-mounted device also serves as an additional panic button. On the side of the device, a small panic button exists. When the user double-presses the button, a panic signal is transmitted to the user's smartphone via bluetooth. When the panic has been successfully triggered, the ear-mounted device vibrates, to give the user confirmation that the panic was successfully triggered.

### 4-I) Photo of the User:

Professional rescuers are provided with a photo of the user on the website, which enables them to identify the user during the rescue. As mentioned in the Signup section, the user is prompted to take a picture of themselves as they set up their profile. To view the user's photo, rescuers select “Photo Of User” from the Menu Items on the mobile website. The user photo appears automatically at the top of the desktop website. Underneath the photo, the time and date when the photo was taken is listed.

### 4-J) Emergency Contact Info:

When rescuers select “Emergency Contact Info” on the mobile or desktop website, rescuers and loved ones can see the email addresses and cellphone numbers of all designated emergency contacts, the nearest police/ambulance and Rescue Center.
When the rescuer taps on any phone number on their smartphones, the rescuer is presented with the option to either send an SMS or place a phone call to that person. If the rescuer selects SMS, they are instantly transported to an outgoing SMS screen with the emergency contact's phone number automatically entered. If the rescuer selects PHONE CALL, the standard phone call screen appears, and a call is automatically placed to that contact.

### 4-K) Instant Text Chat/Instant Verbal Communications:

Directly after receiving the SMS and email panic message, all emergency contacts and professional rescuers can instantly communicate with each other in the designated text area on the home screen of the website, to share vital information about the user's predicament and previous plans. On the mobile and desktop websites, rescuers simply enter their name in the chat field and then select “START”, as shown in FIG. 26, example (106). After selecting START, a standard chat window appears. Various family, friends and professional rescuers can instantly share key information to help with the rescue. The emergency contacts enter text at the bottom of the window, and after completing the message, they submit the text, and the message is sent to the upper chat window, as is the standard format for instant messaging.
1. The SMS recipient clicks on the web link embedded in the SMS.
2. The rescuer arrives at the user's website.
3. The rescuer enters their name in the chat field and presses START.
4. The rescuer begins chatting with other recipients of the SMS. (aka other Emergency Contacts)
   As detailed in 1-J-3, the user is able to initiate an audio conference call between themselves and the various rescuers.
   In addition to the user's capability to initiate an audio conference call with rescuers, the rescuers also possess the capability to initiate audio conference calls without the user's participation, via the mobile and desktop websites. On the “Emergency Contact Info” screen, as with the user's application, rescuers select a listed emergency contact and then press “ADD TO CALL”. If the rescuer's laptop or other computer is fitted with a microphone and speakers, (as with nearly all laptops and all smartphones), they can orally converse with several fellow rescuers at once. The only limitation to the number of rescuers who can participate is regulated by their available bandwidth connection to the internet. As with the user application, on the website, rescuers can incrementally reduce the bit rate of the phone communication, to create additionally available bandwidth, allowing for more conference call attendees.

### 4-L) Medical Info:

On the mobile and desktop websites, rescuers and loved ones can see any relevant medical info relating to the user, such as blood type, ailments, known allergies, etc. by selecting “Medical Info” from the Menu Items. After selecting Medical Info, a separate window opens which contains all medical information which the user previously entered via the smartphone application. User's are instructed to enter all relevant medical information when they first sign up for the Ultimate Life Protector service, and users can also update the text for this screen in the preferences section of the application.

### 4-M) Panic Status:

A shown in FIG. 26, example (96), at the top of the website, the type of panic is listed (Silent, Loud or Medical Panic) the time the panic was triggered is shown, and it is shown whether or not the panic is currently active or inactive. It is also shown if the user sent a “false alarm message”, indicating that they accidentally triggered a panic. It is also shown if the user entered a “designated false password”, intended to mislead an attacker into believing that the user has canceled the panic.
As mentioned in 1-J-2, when the user has launched an “I AM SAFE” signal, the following is shown in the panic status section of the website: “I AM OK. at 7:36 AM, on 02/15/13”. Call to confirm if you wish.” This message is shown in the same area as all panic status updates, in FIG. 26, example (96). When the user selects the I AM SAFE option, FALSE ALARM MESSAGE option, the user's phone ringer automatically increases to the maximum, to enable the user to hear phone calls from rescuers who will likely wish to call the user to confirm that the user is indeed safe.

### 4-N) User's Home Address:

The user's home address is listed at the top of the desktop website, in addition to the user's cellphone number. On the mobile website, rescuers can find the user's home address by selecting “Address of User” as shown in FIG. 28, example (114).

### 4-O) Pulse Monitor Notifies the Website:

If the user has purchased the optional Pulse Monitor, (all optional accessories detailed below in #6) rescuers can see the realtime heart rate of the user in the medical info section of the website. When the user's pulse exits the safe range, a medical panic is automatically triggered and the website flashes red, indicating that the user's pulse has reached a dangerous level. This is displayed on the front page in the panic status section of the website, regardless of whether the rescuer has navigated to the “Medical Info” section of the website. In other words, when the user's pulse reaches a dangerous level, the user's pulse status is forced to the front of the website, to instantly notify all rescuers of the user's current pulse status.

### 4-P) Brainwave Monitor Notifies the Website:

If the user has purchased the optional Brain Wave Monitor, rescuers can see if the user is having a seizure, a stroke, or many other brain conditions. The brainwave monitor automatically sends the user's current brain status to the website, so rescuers can understand the nature of the user's brain related issue. In addition to the visual brainwave monitor, a basic text description of the user's brain-related condition is shown next to the brainwave monitor. As with the pulse monitor described in 4-O, if the user is experiencing a brain related crisis, a medical panic is automatically triggered, and this issue is shown in the panic status section of the website, and the applicable visual monitor is automatically pushed to the front page of the website, regardless of whether or not the site viewer selects Medical Info.

### 4-Q) Breathing Monitor Notifies the Website:

If the user has purchased (and is wearing) the optional breathing monitor, rescuers can determine whether or not the user is breathing, in the medical info section on the website. If the user is has stopped breathing, or is not breathing within a safe range, a medical panic is triggered and the user's breathing status is pushed to the front of the website.

### 4-R) Nano-Blood Probe Notifies the Website:

If the user has purchased and injected the optional Blood Probe detailed in (6-B) below, rescuers can determine whether or not the user's vital blood levels are normal, including whether or not the user's blood reveals the need for a new dose of essential medication. This information is shown on the website in the medical info section, and if the situation becomes urgent, the front of the website is notified with the current urgent status. The blood probe monitor, which is roughly the size of a red blood cell, continues to travel throughout the user's blood stream until it is removed with a doctor's assistance. The blood probe and other optional accessories are detailed in #6.

### 4-S) Medicine Distribution Patch Notifies the Website:

If the user requires a new dose of essential medication, and the user has purchased and is wearing the optional Transdermal Medicine Distribution Patch detailed in (6-G), users who have been instructed by their doctors to receive regular doses of prescribed medicine are able to program the patch to release a predetermined dosage at predetermined time intervals. The user is also able to receive medicine if the blood probe determines that a new dose is unexpectedly needed, and the blood probe communicates with the medicine patch, instructing it to release the correct dose of medicine to the user, which is distributed through the user's skin. The website informs rescuers of the user's situation regarding their medicine in the panic status section of the website and also in the medical info section on the website.

### 4-T) Surgically Implanted Large Dose Medicine Distribution Chamber Notifies the Website:

This medicine dispersal and containment chamber is surgically implanted in the user. (Detailed in 6-H) When the blood probe determines that the user urgently requires large doses of the medicine in question, (such as the commonly large doses needed for anti epileptic seizures) the medicine distribution chamber releases the drug. The chamber is surgically positioned so that the refill entrance is readily accessible beneath the skin. The doctor injects the refill of the drug directly through the user's skin, into the distribution chamber. If a user in question suffers from severe epileptic seizures, when the brainwave monitor determines that a seizure has begun, the brainwave monitor signals the ULP application, and from the smartphone, the application directs the proper dose of medicine to be released from the implanted Large Dose Medicine Distribution Chamber. When the Chamber releases the medicine, the user's medicine status is displayed in large type font at the top of the home screen of the website, informing all rescuers. Also, if the user's medicine status is in crisis, this info is sent via SMS and email to all Emergency Contacts.

### 4-U) Automatically Activated Electrical Cardiac Resuscitation Pads Notifies the Website:

Two portable pads stick to the user's chest with an adhesive. (Detailed in 6-I) The pads, which contain sensitive sensors and local CPU processing capabilities to receive and interpret the sensor readings, are able to discern whether or not they are correctly fastened to the person's chest, and are also able to detect the user's heart rate at all times. When the heart stops beating, the sensors recognize this, a medical panic is automatically triggered, and the pads administer the correct amount of electrical impulse to defibrillate the user's heart. The process automatically ceases as soon as the sensors determine that a safe heart rate has been restored. The user's heart is monitored on the main home screen of the rescue website automatically as soon as the irregular heart-related issue is discovered by the heart sensor/pads. In addition to the visual heart monitor on the website, a basic text description of the user's medical issue is shown on the front of the website, along with a visual monitor of the user's heart functions. All defibrillation activity is listed in the Panic Status section of the website.

### 5. 24/7/Rescue Center:

Hundreds of trained Ultimate Life Protector™ personnel are enlisted to always be prepared to receive a panic signal via SMS or email from any user, at any hour, on any day.
These trained personnel await the panic messages from multiple computer centers, located hundreds of miles apart throughout North America. This is necessary to guarantee continuous service, even when a severe local disaster strikes, potentially causing one particular rescue center to lose power. If power is lost in one or even several regional Rescue Centers, service is never disrupted because distantly located redundant centers seamlessly continue to provide service.
The rescue personnel are instructed to adhere to the following guidelines:
A) When any panic message is received, rescuers first must click on the user's unique web link within the panic message, bringing them to the user's rescue website.
B) Upon arriving at the website, rescuers should immediately begin listening to streaming audio from the scene, and if available, video and or photos. If it is impossible to discern any information useful in determining the severity of the user's situation, the rescuer should contact the nearest rescue precinct to the user, with the correct phone number for this precinct automatically provided on the header of the user's website. After the user's own location is determined, the nearest police and ambulance is displayed, with their contact info.
C) The rescuer tells the local rescue dispatcher that the user is in potentially life threatening danger, and provides them with the user's unique location website, “http://www.LocateLovedOne.com/[UNIQUE USER NAME]”. The local 911 precinct is instructed to find and rescue the user immediately, using the LocateLovedOne website.
D) After notifying the local police precinct, rescuers remain available to communicate with the user's emergency contacts via the chat text section on the home screen of the rescue website, described earlier in (4-K).
E) The rescue center maintains continuous communications with the public rescue dispatcher throughout the crisis and relays all status updates to the loved ones, emergency contacts, and campus security if applicable.
F) In cases where the user is able to speak freely, under no duress, the user is able to call the rescue center directly, and the rescue center can connect the user's phone call as with a conference call, as detailed in (1-J-3) so the user can simultaneously speak with the rescue center, the local 911 precinct, and possibly with the user's parent, guardian or other loved one if the user suggests it to the rescue center. If the user initially believes that it is safe to place a phone call to the rescue center and rescuers, but suddenly learns that it is not safe for this conference call to be audible, there is a large MUTE button on the user's screen during the call. When any participant selects MUTE, all audio from that participant's computer is silenced, and all other website attendees can see that this participant has silenced their audible audio. To be clear, if the user selects MUTE as described, audio from the user still continues to stream to the website where it is recorded for later use. When the user selects MUTE, they are silencing audible audio from being heard in their present location, on the user's own smartphone. During this MUTE mode, sound from the user's position is discreetly transmitted to and recorded on the website for rescuers to examine in near-realtime, and also at a later time.
G) If the rescue center receives a “False Alarm Message”, or if the user cancels the panic, the rescue center is directed to immediately call the user's cell phone, to confirm that the user is indeed safe. If the rescue center determines that the user is safe, all emergency contacts and 911 are to be immediately notified by the rescue center.
H) If the rescuer is able to reach the user via phone, the rescuer asks the user to say their password. If the user says the correct password, the local 911 precinct is immediately notified that the user is now safe, and no longer in need of professional rescue services.
I) If the user gives the designated “FAKE” password, the rescuer notifies the 911 precinct that the user is attempting to deceive an attacker, by pretending to cancel a panic, but in reality, the user has purposely given the designated fake password, indicating that the user is under duress and is falsely attempting to convince an attacker that the user is canceling the panic mode. In reality, the rescuers continue to search for and rescue the user. To be clear, if the user enters a WRONG password, the panic is not canceled, and the user is prompted to enter the correct password. Only when the user enters the DESIGNATED FALSE PASSWORD, do the actions described above take place.

### 6. Optional Accessories:

### 6-A) Ear-Mounted Video Camera: (Doubles as an Additional Panic Trigger Button)

A small, ear-mounted video camera rests on the user's ear, with the lens jutting out past the user's hair, aiming directly forward, as shown in FIG. 35, example (136). The width of the tiny lens is similar to that of a paper clip, so the user barely notices that they are wearing the device. Rescuers can see streaming video from the exact vantage point of the user, to drastically enhance their understanding of the nature of the user's predicament during a panic. The video data streams to the user's smartphone, where the ULP application uploads the video to the rescue website. The camera also contains an audio microphone and streams audio along with video to the user's smartphone, where it streams to and is recorded on the rescue website.
The user is also able to trigger a panic with this ear-mounted video accessory, in addition to the standard bluetooth panic trigger button. The user double clicks the button on the rear of the ear-mounted video camera, and a Silent Panic signal is sent via bluetooth to the user's smartphone.
This device is designed to be an additional, convenient way for users to retain quick access to a panic button, while simultaneously offering unprecedented vantage point video. With the ear mounted video camera, users are able to trigger a panic even if their clothes have been removed.

### 6-B) Pulse Monitor, Worn as a Bracelet: (Doubles as an Additional Panic Trigger Button)

This flexible bracelet device contains sensors which constantly monitor the user's pulse, always confirming that it is within a safe range. If the user's pulse stops or becomes dangerously irregular, the bracelet sends a signal via bluetooth to trigger Medical Panic on the user's phone. From the website, the rescuers are able to view the user's pulse via a visual pulse monitor, which appears on the front of the website if the user's pulse enters a dangerous range. If the user's pulse is within a normal range, but the user suddenly finds themselves in a dangerous crisis, they can simply double-press the small button on the edge of the pulse monitor, to trigger a panic. In addition to sensors which detect the user's pulse rate, the pulse monitor sensors also are able to detect whether or not the monitor is being worn correctly by the user. In other words, if the user removes the pulse monitor from their wrist, no Medical Panic is triggered, because the device is aware that it is no longer correctly positioned on the user's wrist. As with the ear-mounted video camera, the pulse monitor contains a panic trigger button. When the user double-clicks this button, a panic signal is transmitted via bluetooth to the user's smartphone.

### 6-C) Brainwave Monitor: (Doubles as an Additional Panic Trigger Button)

A flexible hat containing electrodes constantly monitors the user's brain activity. If the user has frequent seizures, for instance, when the user begins to have a seizure, the brainwave monitor instantly sends a signal via bluetooth to the user's smartphone to trigger medical panic. On the main screen of the website, in large red letters, it is shown that the user is currently having a seizure. The brainwave monitor detects all brain-related crises such as stroke, blunt impact or seizure, and automatically triggers medical panic. Medical professionals can view the brain waves to better understand the type and severity of the brain issue. The sensors on the brainwave monitor also are able to detect whether or not the monitor is being worn correctly by the user. In other words, if the user removes the brainwave monitor from their head, no Medical Panic is triggered, because the device is aware that it is no longer correctly positioned on the user's head.
If the user's brainwaves are safely within a normal range, but the user suddenly find themselves in a dangerous crisis, they double-press the small panic button which resides on the edge of the brainwave monitor hat, and a panic is triggered.

### 6-D) Breathing Monitor: (Doubles as an Additional Panic Trigger Button)

The breathing monitor rests in the user's shirt pocket and remains in place with a sturdy metal clip. If the user stops moving/breathing, the device sends a medical panic signal to the user's smartphone. The user's breathing status is shown on the front of the website if the breathing is dangerously abnormal or absent. Users are encouraged to wear this device as they sleep, as well as throughout the day. If the user stops breathing, a medical panic is triggered. The breathing monitor contains sensors which are able to detect whether or not the monitor is correctly positioned on the user. If the user removes the breathing monitor, no panic is triggered because the device senses that it is not being worn.
If the user is breathing normally, but they suddenly find themselves in a dangerous crisis, they double-press the small panic button which resides on the breathing monitor and a panic is triggered.

### 6-E) Surgically Implanted Large Dose Medicine Distribution Chamber:

When the blood probe (as explained below in (6-G) determines that the user urgently requires large doses of the medicine in question, (such as anti-convulsant medicine to treat a seizure) the medicine distribution chamber releases the drug, using the identical mechanical procedure as the medicine patch detailed in (6-I). Namely, the medicine reservoir remains sealed within the chamber until the robotic levers releases the medicine directly into the user's bloodstream, when it receives this instruction from the blood probe, or at a predetermined time. If a doctor wishes to schedule a time for the medicine to be released, as explained in (6-H) the user and/or doctor interface with the device and program the desired instructions. The chamber is surgically positioned so that the refill entrance is readily accessible near the surface of the user's skin. The doctor simply injects the refill of the drug directly through the user's skin, into the distribution chamber. There are multiple, separate chambers designed to house different medicines, all separate from each other, and all sealed off from the user's bloodstream until the user needs them. The material surrounding the reservoir responds to the injection by forming a seal over the newly punctured hole. This is done to prevent medicine from seeping into the user's blood stream until it is desired. In other words, after an injection is carried out, the puncture caused by the injection is automatically re-sealed, to prevent more medicine from being administered.
If the user in question is allergic to bee stings, when the blood probe determines that the user has been stung by a bee, the probe signals the ULP application, and from the smartphone, the application directs the proper dose of Epinephrine to be released from the implanted Medicine Chamber. The chamber is comprised of several sub-chambers, which can each contain different medicines to be released on different schedules. For instance, one chamber can contain Epinephrine, and 4 chambers can contain insulin. Regarding the power for the device, as with the blood probe, the Chamber is recharged with a wireless platform (detailed in (6-H). When the battery runs low on the Chamber, the Chamber sends a signal to the user's phone, directing the user to self-send an SMS, informing them that it is necessary to recharge the Medicine Chamber. The user holds the charging platform near the location of the implanted device, and when the charge is complete, the Chamber instructs the user's phone to send the user an SMS on their smartphones, notifying the user that the charge is complete. When the blood probe directs the Chamber to release the medicine, the user's medicine status is displayed on the home screen of the website, informing all rescuers.

### 6-F) Automatically Activated Electrical Cardiac Resuscitation Pads:

Two portable pads stick to the user's chest with an adhesive. The pads, which contain sensitive sensors and local CPU processing capabilities to receive and interpret the sensor readings, are able to discern whether or not they are correctly fastened to the person's chest, and also able to detect the user's heart rate at all times. When the heart stops beating, the sensors recognize this, and the pads administer the correct amount of electrical impulse to defibrillate the user's heart. The process automatically ceases as soon as the sensors determine that a safe heart rate has been restored. A medical panic is triggered and all heart information is pushed to the front of the rescue website. The pads are recharged with the wireless charging pad detailed in (6-H).

### 6-G) Nano-Blood Probes:

In the near future, when it is projected by such renowned luminaries as Ray Kurzweil that nano-robotics will quickly become as ubiquitously available as smartphones are today in 2013, minuscule nano blood probes will be available for any application people wish to apply them towards. Ultimate Life Protector™ intends to harness the capabilities of these probes, tasking them with numerous responsibilities in the service of enhancing the health of all users, and continuously monitoring the user's health condition in order to notify the user's doctor and Emergency Contacts when any number of potential health crises arise, and in some cases, the nano probes autonomously instruct the medicine distribution devices to release the appropriate doses of available medicine.
These ULP nano-probes can circulate through the user's body continuously until removed. The probes can be 5 micrometers tall, slightly smaller than standard red blood cells. The devices can be constructed with carbon atoms in a diamond pattern to maximize their strength. They contain CPU, robotic arms capable of grasping and analyzing various cells and other objects; with sensors capable of detecting the presence of any physical substance. The probe is able to seek out and destroy certain designated cells with a robotic drill and vise, as directed by the user and their authorized medical advisors. In addition to recharging the battery via the magnetic charging pad described in (6-H) below, the blood probes have the ability to harness energy present in glucose in the user's bloodstream. The probes can replenish their batteries by converting the glucose into usable electricity.
After injecting the blood probes, the user's blood levels can be constantly monitored by the probes to ensure that proper levels of all substances are within healthy ranges. If, for instance, the user requires a steady dose of medicine to prevent the onset of psychotic symptoms if the user suffers from severe Schizophrenia, when the blood probes detect that the user's blood is running low on the medicine in question, the probes send a signal to the user's phone, which then signals the user's medicine distribution patch, or the Large Dose Medicine Distribution Chamber detailed in (6-E) above), to release the appropriate dose of medicine to the user. The Medicine Distribution Patch is described in detail in (6-G) below. The blood probe links with the Surgically Implanted Large Dose Medicine Distribution chamber (detailed in (6-G), the blood probes can signal the medicine chamber to release larger doses of medicine than the patch can contain. The large dose chamber can also slowly release medicine as is necessary to maintain symptom relief for a user with Schizophrenia, requiring fewer refills than the medicine patches.
The blood probes can constantly monitor all key blood levels, and if a crisis is detected because, for instance, the user's oxygen or insulin levels are dangerously low, the probes send a signal to the user's phone, which then triggers a medical panic, notifying all emergency contacts that the user is having a medical crisis. The specific, known details of the crisis as determined by the probes are sent to the website for rescuers to understand the nature of the emergency.
Users and doctors can interface with and recharge the blood probes by using the wireless charging and interface device detailed below in (6-H), in addition to the conversion of blood glucose mentioned above.

### 6-H) Wireless Magnetic Charging and Blood Probe Interface Pad:

To charge the battery inside the Wireless Charging Pad, it can be plugged into a wall outlet. Once the charger battery is full, the user can bring the charging pad with them, in a mobile fashion, enabling the user to recharge their blood probes and other accessories while they are away from stationary power. It is also possible to use the charger/interface pad if the battery is depleted, while the pad is plugged into the wall outlet.
The blood probes are magnetized to the opposite polarity of the charging/interface pad, hence, when the probes arrive at the user's arm during normal blood circulation, the probes remain stationary when they reach the magnetic field from the charging/interface pad. While the probes remain in the magnetic field, the probes are recharged, and the probes are also reprogrammed with new tasks, by the user and their doctor.
The charging and interface pad links via WIFI to a computer terminal, through a secure web portal, the user and doctor are able to transmit new instructions to the probe, as the battery is being recharged. When the power has been fully restored, the probe sends a signal to the user's phone via the charging pad. When the user's phone receives this signal, an SMS is sent to the user's phone along with the designated medical contact, to notify them that the probes have been successfully recharged, and when applicable, when the probes have successfully received their new instructions.

### 6-I) Transdermal Medicine Distribution Patch:

With the controllable medicine distribution skin patch, users who have been instructed by their doctors to receive regular doses of prescribed medicine are able to program the patch to release a predetermined dosage at predetermined time intervals. The patches are attached to the user's skin via an adhesive as in FIGS. 37 and 38, example (138), and once correctly attached, the patches remain in place, even if the user enters water. As shown in FIG. 37, example (140) before the patch has been instructed to distribute the medicine, the medicine shield blocks the medicine reservoir, example (142) from contacting the skin. As shown in FIG. 38, example (146), when the user and their doctor instruct the medicine shield to move to the side on the motorized levers, the medicine reservoir, example (142) is directly exposed to the user's skin, example (144) where the medicine is absorbed into the skin at the predetermined dosage. After the desired amount of medicine has been dispersed, the motorized levers re-seal the medicine shield, example (140), blocking further absorption.
As one example, with a Schizophrenic patient whose doctor prescribes a steady dosage of a medicine, the Medicine Distribution Patch automatically withholds and releases medicine transdermally, according to the instructions entered by the doctor.

### How the Patch Functions:

The user, while consulting with his doctor, is able to issue instructions for the Patch through the user's individual web page. (www.LocateLovedOne.com/[UNIQUE USER NAME])
a) The user and doctor, or anyone who wishes to modify the medicine distribution settings, must prove that they are authorized to modify these settings, by subjecting them to multiple layers of password security.
b) After the correct passwords have been entered, the user and doctor determine the dosages to be released at the appropriate time intervals.
c) The doctor fills the drug reservoir for each patch. User's can theoretically wear over 12 patches if there is enough skin available for patches without excessive hair. Body hair reduces the efficiency of the medicine transfer. The drug reservoirs can be refilled while they are still adhesed to the user's skin, and can also be refilled before the user attaches the patches.
d) Users can recharge the batteries in the patches without removing them from their skin, by holding the wireless charging pad next to each patch, until the patch sends an SMS to the user's phone, notifying them that the device has been fully charged.
e) The patch is designed so that the medicine is kept in a separate compartment from the user's skin until it is needed. In other words, the medicine does not make contact with the user's skin until the user has decided for their skin to make contact, and programmed the device to release the medicine at the desired times via the user's unique web page. (www.LocateLovedOne.com/[UNIQUE USER NAME])
   When the patch receives an instruction to administer the medicine, a thin barrier slides to the side, enabling the drug reservoir to make contact with the user's skin. Multiple compartments are available with separate sliding barriers, so the medicine can be deliberately administered in a staggered fashion, at whichever schedule the user and doctor have chosen through the web portal above.
   Patch Interfaces with the ULP application, Website, Emergency Contacts and the Rescue Center:
   When all doses are administered, the patches send a signal to the user's cellphone, and the ULP application notifies all emergency contacts, the website and the rescue center that the medicine has been successfully administered.
   After any dose is administered, the current remaining amount of medicine in the drug reservoirs is also transmitted to the website. When the sensors in the drug reservoirs determine that a refill is urgently necessary, the patch(es) trigger a Medical Panic, alerting all emergency contacts and the Rescue Center of the situation regarding the medicine.
   If the patch malfunctions and does not successfully administer the medicine, a Medical Panic is triggered and the malfunction is described on the front of the website.
      Blood Probe Communicates with Patch:
      When users and doctors instruct the blood probe to assess levels of an important substance, and that substance has fallen below safe levels, the blood probe signals the ULP application which then signals the medicine distribution skin patch to release the desired dosage of the medicine in question, directly through the user's skin via the skin patch.
      One example of the blood probe interacting with the Patch, sequential actions are as follows:
a) Blood probe determines that the user is in need of a dose of the medicine available in the skin patch.
b) The blood probe notifies the ULP application.
c) The user's smartphone signals the Patch via bluetooth, instructing it to administer the correct dose of medicine.
d) When the blood probe observes that the optimal levels of the drug have entered the blood stream, the Patch sliding barrier closes, sealing off the drug from the user's skin.

Referring now to the figures, the following reference numbers may refer to elements of the invention:

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention.

What is claimed is:

1. A method for disseminating information regarding a problem, comprising:
providing a mobile device wirelessly connectable to a network;
receiving and storing contact information corresponding to a designated list of information recipients;
receiving, via the mobile device, a signal from a user indicating the problem;
receiving, via the mobile device, information regarding the problem;
transmitting an indication of the problem to a rescue clearinghouse via the network;
prompting a participant of the rescue clearinghouse, different from the user, to make a decision about a course of action regarding the problem; and
at least one of transmitting the information regarding the problem to the information recipients from the designated list and transmitting the information regarding the problem to a government rescue organization, based at least in part on the decision.

2. The method for disseminating information regarding a problem as claimed in claim 1, further comprising:
providing a locating device connected to the mobile device; and
recording a location of the user in real time via the locating device to produce location information,
wherein the information regarding the problem comprises the location information.

3. The method for disseminating information regarding a problem as claimed in claim 2, wherein the information regarding the problem comprises the location information for a period of at least one minute prior to at least one minute after the step of receiving the signal from the user indicating the problem.

4. The method for disseminating information regarding a problem as claimed in claim 2, wherein the information regarding the problem comprises the location information for a period beginning after the step of receiving the signal from the user indicating the problem to at least one minute afterward.

5. The method for disseminating information regarding a problem as claimed in claim 2, wherein the recording the location of the user in real time comprises recording the location of the user in discrete time intervals that depend at least in part on a battery power of the mobile device.

6. The method for disseminating information regarding a problem as claimed in claim 2, wherein the location information comprises instructions to locate the user based at least in part on an information recipient location.

7. The method for disseminating information regarding a problem as claimed in claim 1, further comprising:
providing a recording device connected to the mobile device and configured to record at least one of audio, video, and image; and
recording at least one of audio, video, and image in real time via the recording device to produce recording information,
wherein the information regarding the problem comprises the recording information.

8. The method for disseminating information regarding a problem as claimed in claim 7, wherein the recording device comprises a head-mounted video recorder wirelessly connected to the mobile device, and wherein the step of recording comprises pointing the head-mounted video recorder in a direction corresponding to the problem.

9. The method for disseminating information regarding a problem as claimed in claim 7, wherein the information regarding the problem comprises the recording information for a period of at least one minute prior to at least one minute after the step of receiving the signal from the user indicating the problem.

10. The method for disseminating information regarding a problem as claimed in claim 7, wherein the information regarding the problem comprises the recording information for a period beginning after the step of receiving the signal from the user indicating the problem to at least one minute afterward.

11. The method for disseminating information regarding a problem as claimed in claim 7, wherein the recording comprises recording audio.

12. The method for disseminating information regarding a problem as claimed in claim 1, wherein the information regarding the problem comprises a time stamp of the step of receiving the signal from the user indicating the problem.

13. The method for disseminating information regarding a problem as claimed in claim 1, further comprising prompting the user for a password, receiving a designated false password from the user, and indicating that the password is correct, to thereby deceive a perpetrator.

14. The method for disseminating information regarding a problem as claimed in claim 1, wherein the receiving the signal from the user indicating the problem comprises receiving a false password from the user.

15. The method for disseminating information regarding a problem as claimed in claim 1, wherein the information regarding the problem comprises medical information of the user.

16. The method for disseminating information regarding a problem as claimed in claim 1, further comprising:
providing a sound speaker connected to the mobile device; and
after receiving the signal from the user indicating the problem, emitting a noise from the sound speaker having a loudness at least 60 decibels at a distance of three feet from the sound speaker.

17. The method for disseminating information regarding a problem as claimed in claim 1, further comprising providing a keyfob wirelessly connectable to the mobile device and comprising a panic button, wherein receiving the signal from the user indicating the problem comprises receiving a pressed button signal at least twice in succession from the keyfob.

18. The method for disseminating information regarding a problem as claimed in claim 17, wherein the panic button comprises at least one of a medical panic button and a silent panic button.

19. The method for disseminating information regarding a problem as claimed in claim 1, further comprising providing a monitor connected to the mobile device, wherein receiving the signal from the user indicating the problem comprises receiving the signal from the user via the monitor, wherein the monitor comprises at least one of a brainwave monitor, a heart pulse monitor, a breathing monitor, and a nano-probe blood monitor.

20. The method for disseminating information regarding a problem as claimed in claim 19, wherein the monitor activates at least one of an automatic cardiac defibrillation pad, a transdermal medicine distribution patch, and a surgically implanted medicine distribution chamber.

21. The method for disseminating information regarding a problem as claimed in claim 1, wherein the transmitting information regarding the problem to the information recipients from the designated list comprises transmitting information via an information server, accessible by the information recipients via an Internet website.

22. The method for disseminating information regarding a problem as claimed in claim 1, further providing an online chat module via the Internet website accessible by the information recipients to thereby enable the information recipients to electronically communicate via the network.

23. A method for disseminating information regarding a problem, comprising:
providing a mobile device wirelessly connectable to a network;
receiving and storing contact information corresponding to a designated list of information recipients;
receiving, via the mobile device, a signal from a user indicating a safe time period;
measuring an elapsing of the safe time period; and
either a) or b) but not both:
a) within the safe time period, receiving a completion indication from the user;
b) transmitting an indication of a problem to a rescue clearinghouse via the network; prompting an operator of the rescue clearinghouse, different from the user, to make a decision about a course of action regarding the problem; and at least one of transmitting the information regarding the problem to the information recipients from the designated list and transmitting the information regarding the problem to a government rescue organization, based at least in part on the decision.

24. The method for disseminating information regarding a problem as claimed in claim 23, further comprising providing a warning to the user at a predetermined time before the elapsing of the safe time period, so as to provide the user with an opportunity to cancel the timed dissemination of the rescue information before the elapsing of the safe time period.
